(19) United States
(12) Patent Application Publication
(10) Pub. No.: US 2026/0087389 A1
(43) Pub. Date: Mar. 26, 2026

(54) LOW-OVERHEAD FAULT-TOLERANT QUANTUM COMPUTATION VIA MEASUREMENT OF LOGICAL OPERATORS

(71) Applicant: International Business Machines Corporation, Armonk, NY (US)

(72) Inventors: Dominic Williamson, Redwood City, CA (US); Theodore James Yoder, Mohegan Lake, MA (US)

(21) Appl. No.: 18/897,427

(22) Filed: Sep. 26, 2024

(51) Int. Cl. G06N 10/20; G06N 10/60; G06N 10/70

(52) U.S. Cl. CPC G06N 10/20; G06N 10/60; G06N 10/70

(57) ABSTRACT

One or more systems, devices, computer program products and/or computer-implemented methods of use provided herein relate to low-overhead fault-tolerant quantum computation by gauging logical operators. For example, a system can comprise a memory that can store computer executable components and a processor that can execute the computer executable components stored in the memory. The computer executable components can comprise a graph selection component that can select an auxiliary graph. The computer executable components can further comprise a measurement component that can measure a logical operator by executing, on a quantum system, a deformed quantum stabilizer code based on the auxiliary graph.

### BACKGROUND

The subject disclosure relates to quantum error correction theory and, more specifically, to low-overhead fault-tolerant quantum computation via measurement of logical operators.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable low-overhead fault-tolerant quantum computation via measurement of logical operators are discussed.

According to an embodiment, a system is provided. The system can comprise a memory that can store computer executable components. The system can further comprise a processor that can execute the computer executable components stored in the memory, where the computer executable components can comprise a graph selection component that can select an auxiliary graph. The computer executable components can further comprise a measurement component that can measure a logical operator by executing, on a quantum system, a deformed quantum stabilizer code based on the auxiliary graph.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can employ low-overhead fault-tolerant quantum computation to measure a logical operator in accordance with one or more embodiments described herein.

FIG. 2 illustrates another block diagram of an example, non-limiting system that can employ low-overhead fault-tolerant quantum computation to measure a logical operator in accordance with one or more embodiments described herein.

FIG. 3 illustrates diagrams of example, non-limiting structures associated with measurement of a logical operator in accordance with one or more embodiments described herein.

FIG. 4 illustrates a diagram of example, non-limiting representation of an auxiliary graph employed as a ladder between surface codes in accordance with one or more embodiments described herein.

FIG. 5 illustrates diagrams of example, non-limiting tanner graphs and matrices associated with measurement of a logical operator in accordance with one or more embodiments described herein.

FIG. 6 illustrates diagrams of example, non-limiting tanner graphs that can be employed to measure a logical operator in accordance with one or more embodiments described herein.

FIG. 7 illustrates additional diagrams of example, non-limiting tanner graphs that can be employed to measure a logical operator in accordance with one or more embodiments described herein.

FIG. 8 illustrates diagrams of example, non-limiting graph structures associated with measurement of a logical operator in accordance with one or more embodiments described herein.

FIG. 9 illustrates a diagram of an example, non-limiting tanner graph of a bivariate bicycle code in accordance with one or more embodiments described herein.

FIG. 10 illustrates another diagram of an example, non-limiting tanner graph of a bivariate bicycle code in accordance with one or more embodiments described herein.

FIG. 11 illustrates a diagram of an example, non-limiting auxiliary graph associated with a bivariate bicycle code in accordance with one or more embodiments described herein.

FIG. 12 illustrates an example, non-limiting logical operator gauging algorithm in accordance with one or more embodiments described herein.

FIG. 13 illustrates flow diagrams of example, non-limiting method that can employ low-overhead fault-tolerant quantum computation to measure a logical operator in accordance with one or more embodiments described herein.

FIG. 14 illustrates a block diagram of an example, non-limiting operating environment in which one or more embodiments described herein can be facilitated.

Appendix A is a paper entitled “Low-overhead fault-tolerant quantum computation by gauging logical operators,” and this appendix forms part of this specification.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise a graph selection component that can select an auxiliary graph. The computer executable components can further comprise a measurement component that can measure a logical operator by executing, on a quantum system, a deformed quantum stabilizer code based on the auxiliary graph.

Such embodiments of the system can provide a number of advantages, including providing a flexible gauging measurement procedure to measure the logical operator, ensuring low-overhead fault-tolerant quantum computations and providing a gauging measurement procedure that can be applicable to a variety of quantum stabilizer codes.

In one or more embodiments of the aforementioned system, measuring the logical operator can comprise initializing, by the measurement component, respective auxiliary qubits for respective edges of the auxiliary graph. Measuring the logical operator can further comprise performing, by the measurement component, a first measurement on each vertex of the auxiliary graph and on edges adjacent to the each vertex. Measuring the logical operator can further comprise performing, by the measurement component, a second measurement on each edge of the auxiliary graph.

Such embodiments of the system can provide the advantage of a flexible gauging measurement procedure to measure the logical operator. For example, the choice of an auxiliary graph G can allow for a large degree of flexibility in the gauging measurement procedure employed in various embodiments to measure the logical operator. Such flexibility can be advantageous in optimizing the procedure to fit a given instance, and the various embodiments herein can bind the performance for a general family of Low-Density Parity-Check (LDPC) codes. Additionally, the choice of the auxiliary graph G can lead to a lower qubit overhead asymptotically and in explicit examples.

In one or more embodiments of the aforementioned system, measuring the logical operator can further comprise performing, by the measurement component, first repeated measurements of original checks for a first number of cycles, where an original check is a product of original Pauli matrices. Measuring the logical operator can further comprise performing, by the measurement component, second repeated measurements of deformed checks for a second number of cycles, where a deformed check is a product of Pauli matrices based on original qubits and the respective auxiliary qubits.

Such embodiments of the system can provide a number of advantages, including ensuring low-overhead fault-tolerant quantum computations and providing a gauging measurement procedure that can be applicable to a variety of quantum stabilizer codes.

In one or more embodiments of the aforementioned system, a graph construction component can construct the auxiliary graph, where construction of the auxiliary graph can comprise generating, by the graph construction component, for respective original checks overlapping the logical operator, respective pairings of vertices in respective Pauli operator supports of the respective original checks. Construction of the auxiliary graph can further comprise adding, by the graph construction component, respective edges to the auxiliary graph for the respective pairings. Construction of the auxiliary graph can further comprise adding, by the graph construction component, one or more additional edges to the auxiliary graph to ensure a desirable expansion of the auxiliary graph. Construction of the auxiliary graph can further comprise identifying, by the graph construction component, a basis of short cycles of the auxiliary graph.

Such embodiments of the system can provide a number of advantages, including generating a desirable auxiliary graph to measure the logical operator, instead of randomly selecting an auxiliary graph, and improving the edge expansion of the auxiliary graph at the cost of only a few additional qubits.

In one or more embodiments of the aforementioned system, construction of the auxiliary graph can further comprise adding, by the graph construction component, dummy vertices to thicken the auxiliary graph. Construction of the auxiliary graph can further comprise decomposing, by the graph construction component, one or more cycles comprised in the auxiliary graph into one or more smaller cycles.

Such embodiments of the system can provide a number of advantages, including spreading out the cycles comprised in the auxiliary graph across layers and making the auxiliary graph less congested.

In one or more embodiments of the aforementioned system, the graph selection component can select the auxiliary graph based on connectivity constraints of physical qubits corresponding to the logical operator.

Such embodiments of the system can provide a number of advantages, including utilizing a much higher degree of connectivity that is present in good quantum Low-Density Parity-Check (qLDPC) codes and ensuring a near-term implementation of the embodiments disclosed herein because the auxiliary graph can be selected to respect physical connectivity constraints, and then optimized to find the best performance for a fixed device given those constraints.

In one or more embodiments of the aforementioned system, the auxiliary graph can be sufficiently expanding, support constant-length paths between qubits that are in support of a common check in an input quantum stabilizer code, and comprise a low-weight generating set of cycles.

Such embodiments of the system can provide a number of advantages, including reducing the overhead involved in performing a logical measurement in a quantum stabilizer code and providing a fault distance guarantee.

In one or more embodiments of the aforementioned system, a code construction component can construct the deformed quantum stabilizer code via min-weight perfect matching based on the auxiliary graph and checks of the input quantum stabilizer code, such that the deformed quantum stabilizer code can comprise the auxiliary graph and one or more auxiliary qubits.

Such embodiments of the system can provide a number of advantages, including providing a flexible gauging measurement procedure to measure the logical operator, ensuring low-overhead fault-tolerant quantum computations and providing a gauging measurement procedure that can be applied to a variety of quantum stabilizer codes.

In one or more embodiments of the aforementioned system, the logical operator can be a Pauli operator.

In one or more embodiments of the aforementioned system, the logical operator can be a non-Pauli operator, and the deformed quantum stabilizer code can be a non-Pauli code.

Such embodiments of the system can provide a number of advantages, including providing a flexible gauging measurement procedure to measure Pauli as well as non-Pauli operators, ensuring low-overhead fault-tolerant quantum computations during such measurements and providing a gauging measurement procedure that can be applicable to a variety of quantum stabilizer codes and to Pauli as well as non-Pauli operators.

In one or more embodiments of the aforementioned system, employing the deformed quantum stabilizer code can maintain a fault distance associated with the logical operator below a defined threshold.

Such embodiments of the system can provide the advantage of ensuring a guaranteed fault distance, unlike existing techniques in the art.

An embodiment in which the measurement component can measure a logical operator by executing, on a quantum system, a deformed quantum stabilizer code based on the auxiliary graph, where the auxiliary graph is constructed by the graph construction component has the advantages of providing a flexible gauging measurement procedure to measure the logical operator, ensuring low-overhead fault-tolerant quantum computations, providing a gauging measurement procedure that can be applicable to a variety of quantum stabilizer codes, generating a desirable auxiliary graph to measure the logical operator and improving the edge expansion of the auxiliary graph at the cost of only a few additional qubits.

In an exemplary circuit level implementation, the measurement component can initialize an auxiliary qubit for each edge of the auxiliary graph in the |0 [symbol] state. Next, the measurement component can apply a CNOT gate to each adjacent vertex-edge pair in the auxiliary graph with the vertex as the control and the edge as the target. Thereafter, the measurement component can measure Xᵥ on each vertex of the auxiliary graph while maintaining the post measurement state, re-apply the circuit employed to apply the CNOT, and measure Zₑ on each edge of the auxiliary graph. The CNOT gate can be re-applied to each adjacent vertex-edge pair in the auxiliary graph with the vertex as the control and the edge as the target. In this circuit level implementation of the procedure, the measurement component can repeatedly measure deformed checks between measuring Xᵥ and reapplying the circuit, which can allow the vertex qubits to be discarded during this process and reintroduced just before measurement of Zₑ.

According to various embodiments, the above-described system can be implemented as a computer-implemented method or as a computer program product.

### Definitions

Qubit: A qubit is a two level quantum system and the basic unit of quantum information.

Measurement: In quantum computing, a measurement is a process where a quantum state is projected onto an eigenspace of a Hermitian operator, and the associated eigenvalue is observed.

Pauli matrices: Pauli matrices are a standard basis of 2×2 matrices and often denoted by the letters I, X, Y and Z.

Stabilizer code: A stabilizer code is a subspace of quantum states defined by the simultaneous +1 eigenspace of commuting checks.

Check: A check is a product of Pauli matrices that is measured to check if a quantum state is in a code space.

Syndrome: A syndrome is the observed result of measuring a check.

Weight: Weight is the number of non-identity Pauli matrices involved in a check.

Degree: A degree is the number of checks that act on a given qubit.

Logical operator: An operator that enacts a nontrivial transformation within a quantum code space is known as a logical operator.

Tanner graph: A tanner graph is the bipartite connectivity graph between checks and qubits in a code.

Calderbank-Shor-Steane (CSS) code: The CSS code is a quantum stabilizer code where all checks are products of either Pauli X matrices or Pauli Z matrices.

Fault distance or code distance: Fault or code distance refers to the minimum number of errors that can occur before a quantum error correction code fails.

In quantum computing, quantum error correction is central to the preservation of quantum information during a computation on noisy physical qubits. That is, quantum computation should be performed in a fault-tolerant manner to be realizable in practice. Useful fault-tolerant quantum computation can involve the implementation of logic gates on quantum codes, and the measurement of logical operators can be a primitive operation to implement/perform logic gates in Pauli-based computation models. Existing schemes for measuring logical operators typically have a large space and time overhead cost. Recent studies uncovered quantum error-correcting codes that can be implemented with sparse connectivity and constant qubit overhead. However, existing scheme for fault-tolerant measurements of logical operators often do not achieve a low-overhead (i.e., low qubit overhead) for good quantum codes. Existing solutions are not very flexible, and therefore, offer low-overhead measurement of logical operators (i.e., logical measurements) for only a few quantum codes. Thus, methods and techniques (or schemes) to measure logical operators in good qLDPC codes with low overheads in space and time resources are desirable.

Various embodiments of the present disclosure can be implemented to produce a solution to these problems. Embodiments described herein include systems, computer-implemented methods, and computer program products that provide a gauging measurement procedure to implement a fault-tolerant measurement of a logical operator in a quantum error-correcting code by treating the logical operator as a symmetry and gauging it, wherein the gauging measurement procedure can generate a low-overhead. The methods and techniques described herein to gauge the measurements of logical operators can introduce a high degree of measurement flexibility that can be advantageous in minimizing the qubit overhead and in achieving a qubit overhead that is linear in the weight of the operator being measured upto a polylogarithmic factor. Such flexibility can allow the gauging measurement procedure to be adapted to arbitrary quantum codes. The corresponding results provide a new and more efficient approach to implement fault-tolerant quantum computation that can be more tractable for near-term implementation.

The gauging measurement procedure represents a versatile construction in the form of a fault-tolerant quantum code switching, wherein a given logical operator can be measured from a qLDPC code. The amount of fault-tolerance associated with the fault-tolerant code switching can depend on the choice of an auxiliary graph G constructed appropriately. That is, the choice of the auxiliary graph G can affect the gauging measurement procedure employed to measure the logical operator. The fault-tolerance of the code switching can also depend on the number of cycles of syndrome measurement that are performed. The versatile construction described herein is equivalent to a circuit construction that can measure out data qubits directly, which can generate a lower overhead in some cases. In various embodiments, a procedure to construct an appropriate auxiliary graph G while aiming to minimize overhead (i.e., the number of ancilla qubits) is also provided. In some cases of practical relevance, such as with bivariate bicycle codes, the procedure to construct the auxiliary graph G can be simplified. In this regard, exemplary graph constructions exceeding current techniques in the art are described with reference to one or more figures. Although the various embodiments herein are primarily described with reference to Pauli operators, it should be appreciated that in one or more embodiments, the logical operator can also be a non-Pauli operator, and the deformed quantum stabilizer code can be a non-Pauli code. It should be further appreciated that the embodiments described herein can be generalized to architectures beyond superconducting circuits.

In various embodiments, the gauging measurement procedure can be employed to measure the logical operator via a code deformation (e.g., a deformed quantum stabilizer code), wherein the code deformation can employ the structure of the auxiliary graph G to include additional qubits that can enable the measurement of the logical operator with a lower space overhead. For example, in various embodiments, a logical operator gauging algorithm is provided, wherein the logical operator gauging algorithm can comprise a graph selection component, a measurement component, a graph construction component and a code construction component. In various embodiments, the graph selection component can select an auxiliary graph G based on connectivity constraints of physical qubits corresponding to a logical operator L to be measured. For example, the graph selection component can select an auxiliary graph whose vertices are a one-to-one (1-to-1) match with the qubits involved in the logical operator L that is to be measured. In various embodiments, the auxiliary graph G can be sufficiently expanding, support constant-length paths between qubits that are in support of a common check in an input quantum stabilizer code and comprise a low-weight generating set of cycles. In various embodiments, the deformed quantum stabilizer code can be constructed or defined by the code construction component via min-weight perfect matching based on the auxiliary graph G and checks of the input quantum stabilizer code, such that the deformed quantum stabilizer code can comprise the auxiliary graph G and one or more auxiliary qubits.

In various embodiments, the measurement component can measure the logical operator L by executing, on a quantum system, a deformed quantum stabilizer code based on the auxiliary graph G. To measure the logical operator, the measurement component can first apply a rotation to transform the logical operator into the form of a product of Pauli X matrices. Thereafter, the measurement component can initialize respective auxiliary qubits for respective edges of the auxiliary graph G, perform a first measurement on each vertex of the auxiliary graph G and on edges adjacent to each vertex and perform a second measurement on each edge of the auxiliary graph G. For example, the measurement component can initialize an auxiliary qubit for each edge of (in the |0 [symbol] state. Thereafter, the measurement component can measure Xᵥ [symbol] Xₑ on each vertex of G and measure Zₑ on each edge of G. In various embodiments, measurement component can additionally perform first repeated measurements of original checks for a first number of cycles and perform second repeated measurements of deformed checks for a second number of cycles, wherein an original check is a product of original Pauli matrices, and wherein a deformed check is a product of Pauli matrices based on original qubits and the respective auxiliary qubits. These additional measurements can be performed to ensure fault tolerance, whereas only the operations performed by measurement component 204 prior to these additional measurements can be employed if measurement errors are not a concern during the gauging measurement procedure. For example, to ensure fault-tolerance, the measurement component can perform repeated measurements of the original checks for a desirable number of cycles to achieve a desired/defined distance to measurement errors, before initializing the auxiliary qubit and after measuring Zₑ on each edge of G. Additionally, the measurement component can perform a desirable number of cycles of repeated measurements of deformed checks after measuring Xᵥ [symbol] Xₑ on each vertex of G and prior to measuring Zₑ on each edge of G. In various embodiments, employing the deformed quantum stabilizer code to measure the logical operator can maintain a fault distance associated with the L below a defined threshold.

In various embodiments, the auxiliary graph G can be constructed by the graph construction component, which allows for an auxiliary graph G that can be employable in a worst-case scenario. For example, the graph construction component can generate, for respective original checks overlapping the logical operator, respective pairings of vertices in respective Pauli operator supports of the respective original checks, add respective edges to the auxiliary graph for the respective pairings, add one or more additional edges to the auxiliary graph to ensure a desirable expansion of the auxiliary graph and identify a basis of short cycles of the auxiliary graph. For example, assuming (without loss of generality) that the logical operator L is an X-type (i.e., a Pauli X) operator, the graph construction component can begin construction of the auxiliary graph G with a vertex for each qubit [symbol] in the support of the logical operator. Thereafter, the graph construction component can add a (hyper) edge for each check having a Pauli Z or a Pauli Y support (i.e., locally anticommuting property) on [symbol] . Further, the graph construction component can add additional edges to increase the expansion of the auxiliary graph G. This can be achieved via randomized construction or another technique. In an embodiment, the graph construction component can combine an expanded graph with G to increase the expansion of G. Thereafter, the graph construction component can find a basis of short cycles of G. For each cycle, the graph construction component can introduce a Z check on qubits on edges in the cycle and eliminate cycles that are redundant with checks in the code. Such redundancy can occur if the original code checks are overcomplete. In various embodiments, the graph construction component can additionally add dummy vertices to thicken the auxiliary graph G and decompose one or more cycles comprised in the auxiliary graph G into one or more smaller cycles. For example, the graph construction component can add dummy vertices and thicken G to spread out the cycle checks across layers. Further, the graph construction component can ensure that the auxiliary graph G has a cycle basis of only short cycles (e.g., cycles having a length≤w for any choice of w≥3) by decomposing cycles that are larger. However, these additional steps can be eliminated for bivariate bicycles codes.

In comparison to existing methods, the embodiments described herein for measurement of logical operators provide greater measurement flexibility that can improve the qubit overhead costs of such measurements. Such measurement flexibility results from the fact that an arbitrary auxiliary graph G that does not have to match the surface code can be chosen. On the contrary, many existing methods are focused on the surface code. For example, some of the earliest methods are specialized in measuring logical operators on surface codes. Although some of the more recent follow-up methods allow for the measurements of logical operators in more general codes, the auxiliary system employed in such measurements is based on the surface code. As a result, such existing methods incur an additive qubit overhead of at least d². In the various embodiments of the present disclosure, the freedom to choose the auxiliary graph G can provide the advantage of utilizing a much higher degree of connectivity that is present in good qLDPC codes. This further allows for the discovery of explicit examples with lower qubit overhead than that generated by previous/existing methods, and to prove asymptotically that the methods and techniques disclosed herein can achieve an additive qubit overhead of d log² d, where d is the weight of the logical operator being measured. Further, unlike the general procedure introduced by some techniques known in the art, the embodiments described herein can provide a fault distance guarantee, and the auxiliary graph can be selected to respect physical connectivity constraints, and then optimized to find the best performance for a fixed device given those constraints. As a result, a near-term implementation of the embodiments disclosed herein is more promising. These advantages are described in greater detail with reference to one or more figures, where gauging measurement procedures for logical operators for explicit instances of bivariate bicycle codes that have a lower qubit overhead than existing methods have been identified. The various embodiments described herein can be employed to further improve and parallelize measurements of logical operators in qLDPC codes. Additionally, the various embodiments described herein can be widely adopted across quantum computing platforms.

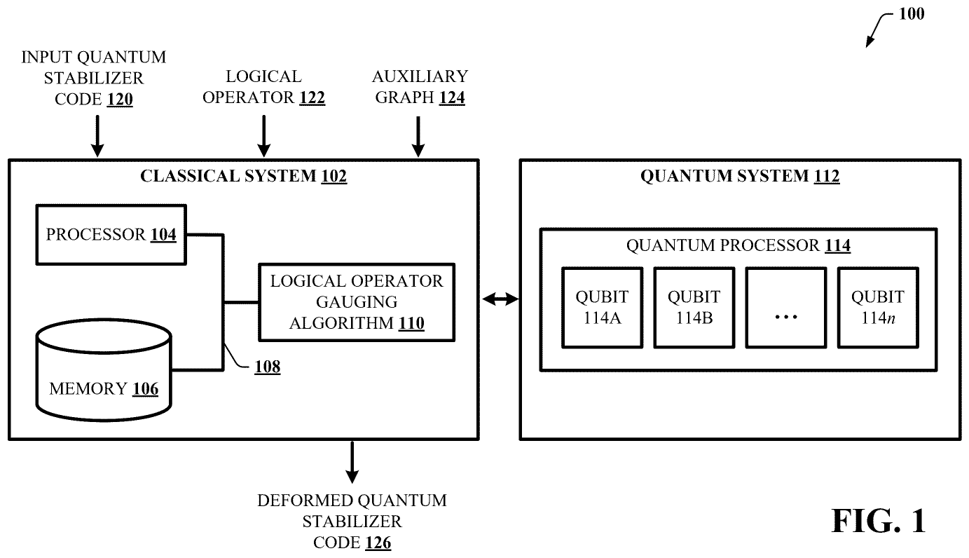

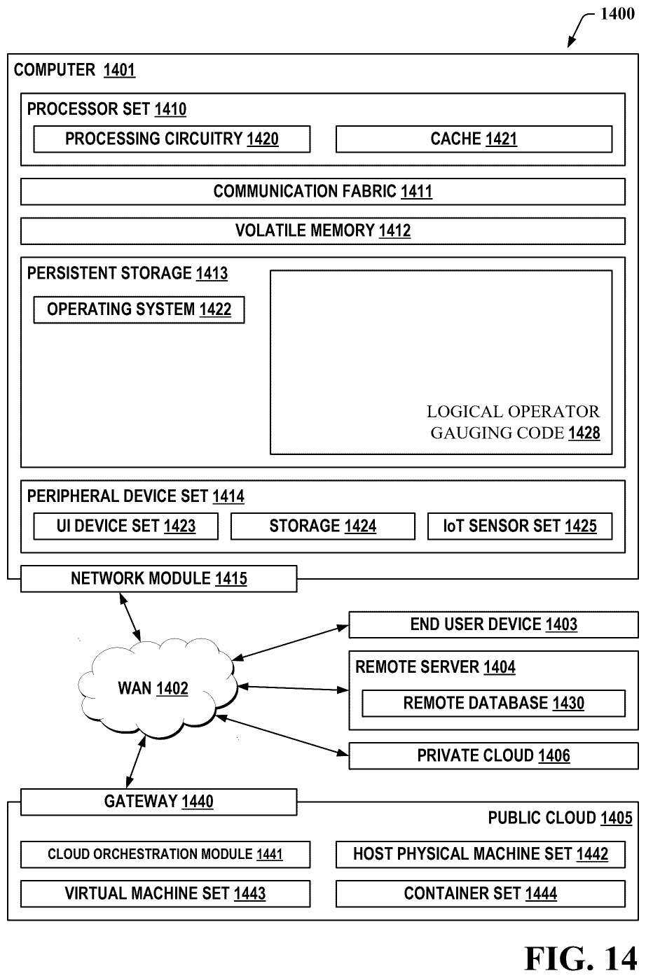

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1400 illustrated at FIG. 14. For example, non-limiting system 100 can be associated with, such as accessible via, a computing environment 1400 described below with reference to FIG. 14, such that aspects of processing can be distributed between non-limiting system 100 and the computing environment 1400. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can employ low-overhead fault-tolerant quantum computation to measure a logical operator in accordance with one or more embodiments described herein.

Non-limiting system 100 and/or the components of non-limiting system 100 can be employed to use hardware and/or software to solve problems that are highly technical in nature (e.g., related to low-overhead fault-tolerant quantum computing, quantum error correction, measurement of logical operators, etc.), that are not abstract and that cannot be performed as a set of mental acts by a human. Further, some of the processes performed may be performed by specialized computers for carrying out defined tasks related to low-overhead fault-tolerant quantum computation via measurement of logical operators. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by improving the overhead involved in performing a logical measurement in a quantum stabilizer code, improving and parallelizing logical measurements in qLDPC codes, providing a fault distance guarantee with low-overhead fault-tolerant quantum computation, etc.

Disclosed herein are one of the first methods for lattice surgery to incur an additive qubit overhead less than d², and the disclosed methods can achieve a constant factor overhead as low as Cd, which represents optimal scaling. In general, the methods and techniques disclosed herein can guarantee an overhead of d log² d, where d is the weight of the logical operator being measured. Additionally, if the auxiliary graph G is constant degree and has a Cheeger constant of at least one (1), the methods and techniques disclosed herein can generate an additive qubit overhead O(w) and preserve the fault distance. In general terms, the additive qubit overhead is the weight, w, of the logical operator times the number of layers needed to sparsify the cycles of G. The number of layers can be bounded by O(log² w), and the time overhead can scale with the distance of the original code. As previously stated, the various embodiments herein can also be applied to non-Pauli operators at the cost of the deformed stabilizer codes becoming non-Pauli codes. Accordingly, the gauging measurement procedure disclosed herein to measure logical operators in quantum stabilizer codes can represent a major advancement in the field of quantum fault tolerance.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., logical operator gauging algorithm 110, graph selection component 202, measurement component 204, graph construction component 206 and/or code construction component 208) to perform one or more actions. In one or more embodiments, memory 106 can store computer-executable components (e.g., logical operator gauging algorithm 110, graph selection component 202, measurement component 204, graph construction component 206 and/or code construction component 208).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise at least one quantum processor, such as quantum processor 114. Classical system 102 can comprise one or more components, such as a memory 106, processor 104, bus 108, and/or logical operator gauging algorithm 110. In an embodiment, logical operator gauging algorithm 110 can be comprised at least partially by quantum system 112. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit.

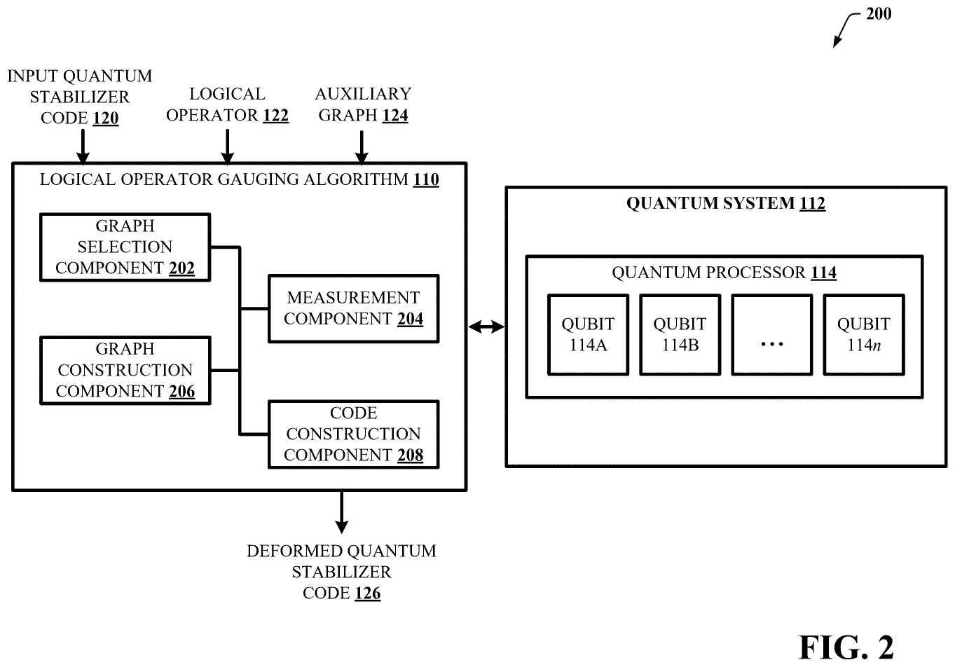

In various embodiments, logical operator gauging algorithm 110 can comprise graph selection component 202, measurement component 204, graph construction component 206 and code construction component 208, as illustrated in FIG. 2. In various embodiments, graph selection component 202 can select an auxiliary graph 124 (i.e., auxiliary graph G) based on connectivity constraints of physical qubits corresponding to logical operator 122 (i.e., logical operator L.). In various embodiments, measurement component 204 can gauge the measurement for logical operator 122. For example, measurement component 204 can measure logical operator 122 by executing, on a quantum system (e.g., quantum system 112), deformed quantum stabilizer code 126 (i.e., deformed code) based on auxiliary graph 124. In various embodiments, measurement component 204 can initialize respective auxiliary qubits for respective edges of auxiliary graph 124, perform a first measurement on each vertex of auxiliary graph 124 and on edges adjacent to the vertex and perform a second measurement on each edge of auxiliary graph 124 to measure logical operator 122. In various embodiments, measurement component 204 can additionally perform first repeated measurements of original checks for a first number of cycles and perform second repeated measurements of deformed checks for a second number of cycles to measure logical operator 122. Herein, an original check represents a product of original Pauli matrices, and a deformed check represents a product of Pauli matrices based on original qubits and the respective auxiliary qubits.

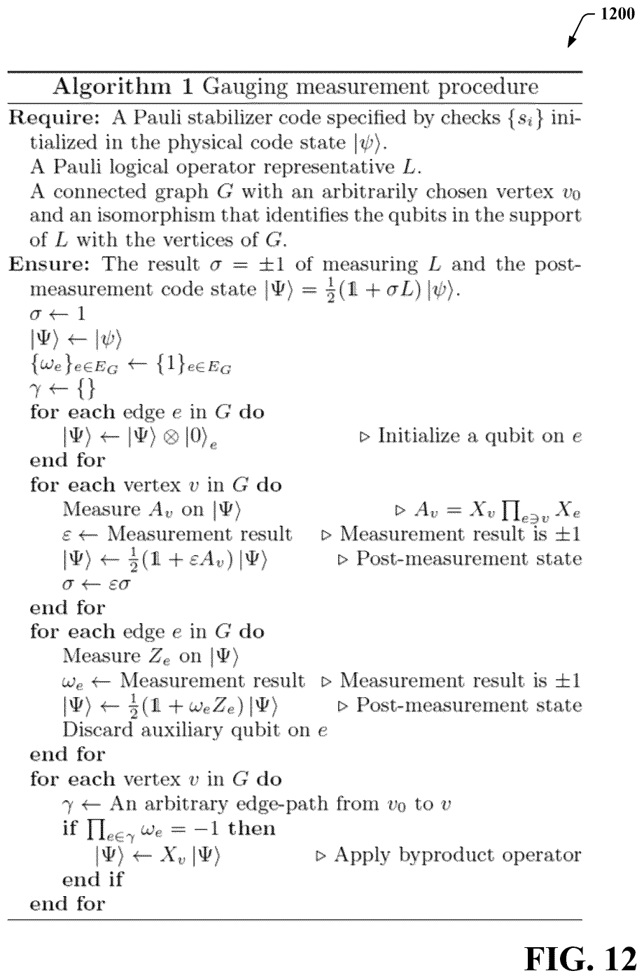

The procedure employed by logical operator gauging algorithm 110 to measure logical operator 122 via gauging (i.e., the gauging measurement procedure) can be elaborated as follows. This procedure is also summarized by Algorithm 1 presented in FIG. 12.

### Gauging Measurement Procedure:

Gauging has been employed widely in physics to construct new models and establish relationships between known models. Although the connection between gauging and quantum codes has been studied, previous work on the subject has focused on gauging procedures that correspond to the initialization and readout of all logical qubits in a code, whereas the various embodiments herein can extend the gauging process to precisely address single logical operators in a large code block.

Various embodiments described herein can be directed to the task of measuring a logical representative L (i.e., logical operator 122) in an [[n, k, d]] qLDPC stabilizer code on qubits specified by checks {sᵢ}. Herein, choosing an appropriate basis for each qubit can ensure that L is a product of Pauli-X matrices. Then, L can be viewed as a symmetry of the qLDPC stabilizer code by identifying the codespace with the groundspace of the Hamiltonan H=−Σᵢ sᵢ. It should be noted that L can commute with every stabilizer. From this point of view, it is natural to project into an eigenspace of L by gauging L.

To gauge L, graph selection component 202 can first select a connected graph G (i.e., auxiliary graph 124) whose vertices identify with the qubits in the support of L. Thereafter, measurement component 204 can introduce an auxiliary gauge qubit on each edge of G, initialized in the 0 state. In physics literature these edge qubits are referred to as gauge qubits. Introducing a set of Gauss's law operators, [symbol] ={Aᵥ}_{v∈V}, where Aᵥ=Xᵥ [symbol] Xₑ, code construction component 208 can project, via measurement, the qLDPC stabilizer code onto an eigenspace of each of the Gauss's law operators, which can result in a deformed code (i.e., deformed quantum stabilizer code 126). In various embodiments, the deformed code can be a subsystem code if the number of edge qubits exceeds the number of Gauss's law operators. The deformed code/subsystem code can be gauge fixed by the choice of initial state for the edge qubits. The gauge fixed code is a stabilizer code specified by the deformed check operators of the original code and a set of flux operators [symbol] ={Bₚ}_{p∈C}, where Bₚ=Π_{e∈p}Zₑ, and p labels a generating set of cycles for G. The flux operators are obtained from a deformation of the initial single body Zₑ checks on the edge qubits. In this regard, non-limiting tanner graph 710 is a tanner graph of deformed quantum stabilizer code 126.

In one or more embodiments, code construction component 208 can construct deformed quantum stabilizer code 126 via min-weight perfect matching based on auxiliary graph 124 and checks of input quantum stabilizer code 120 (i.e. original code), such that deformed quantum stabilizer code 126 can comprise auxiliary graph 124 and one or more auxiliary qubits. In other words, deformed quantum stabilizer code 126 can represent a modified version of auxiliary graph 124.

During the gauging measurement procedure described herein, measurement component 204 can map an original code space (i.e., associated with input quantum stabilizer code 120) into the code space of a deformed code (i.e., deformed quantum stabilizer code 126) which is known as the gauged code. To implement the eigenspace projections of the gauging measurement procedure, the various embodiments herein rely on measuring (e.g., via measurement component 204) the Gauss's law operators. While the initial measurement of each Gauss's law operator can return a random eigenvalue outcome, the product of all outcomes can yield the measured eigenvalue of L. To return to the original code space, measurement component 204 can simply project onto the simultaneous +1 eigenspace of the Zₑ operators on all the edge qubits. To implement this step, measurement component 204 can measure Zₑ on each edge qubit. While the outcome of each measurement can be random, it is possible to find a Pauli-X byproduct operator on the original qubits that can be applied to achieve the same effect as projecting onto all +1 measurement outcome. This step is commonly referred to as ungauging. In various embodiments, employing deformed quantum stabilizer code 126 to measure logical operator 122 can maintain a fault distance associated with logical operator 122 below a defined threshold.

In an exemplary circuit level implementation, measurement component 204 can initialize an auxiliary qubit for each edge of auxiliary graph 124 in the |0 [symbol] state, wherein auxiliary graph 124 can be a fault-tolerant graph. Next, measurement component 204 can apply a CNOT gate to each adjacent vertex-edge pair in auxiliary graph 124 with the vertex as the control and the edge as the target. Thereafter, measurement component 204 can measure Xᵥ on each vertex of auxiliary graph 124 while maintaining the post measurement state, re-apply the circuit employed to apply the CNOT, and measure Zₑ on each edge of auxiliary graph 124. The CNOT gate can be re-applied to each adjacent vertex-edge pair in G with the vertex as the control and the edge as the target. In this circuit level implementation of the procedure, measurement component 204 can repeatedly measure the deformed checks between measuring Xᵥ and reapplying the circuit, which can allow the vertex qubits to be discarded during this process and reintroduced just before measurement of Zₑ. Stated differently, the gauging measurement procedure can be implemented by measurement component 204, via a circuit with no additional qubits, by implementing the Aᵥ measurements as follows. For example, after initializing the edge qubits, measurement component 204 can execute the entangling circuit πᵥ [symbol] CX_{v→e} on a quantum computer (e.g., quantum system 112). Next, measurement component 204 can projectively measure Xᵥ on all vertices in G and maintain the post-measurement state. Finally, measurement component 204 can repeatedly execute the same entangling circuit, followed by a measurement of the edge operators Zₑ, where the edge qubits can be discarded by measurement component 204.

In various embodiments, selecting an appropriate auxiliary graph can be central to the gauging measurement procedure for logical operator 122. For example, it is desirable to employ an auxiliary graph that can be sufficiently expanding (e.g., has a Cheeger constant of at least one (1)), support short (constant-length) paths between qubits that are in the support of a common check in the input code, and comprise a set of cycles that are low-weight generating. Graph selection component 202 can select auxiliary graph 124 based on these criteria.

Alternatively, in various embodiments, a suitable auxiliary graph can be constructed. For example, in various embodiments, graph construction component 206 can generate, for respective original checks overlapping the logical operator 122, respective pairings of vertices in respective Pauli operator supports of the respective original checks. Thereafter, graph construction component 206 can add respective edges to auxiliary graph 124 for the respective pairings and add one or more additional edges to auxiliary graph 124 to ensure a desirable expansion of auxiliary graph 124. In other words, for each original check overlapping logical operator 122, graph construction component 206 can generate a pairing of the vertices in the Y Pauli operator support or the Z Pauli operator support of the check and add an edge to auxiliary graph 124 for each pair. It should be noted that it is desirable for the number of such vertices to be even due to commutativity of the check with the logical operator so that pairing can be possible. According to coding theory, the checks must commute with logical operator 122. Thus, there must exist a support on [symbol] that is even sized. Adding the one or more additional edges can be achieved by randomly adding edges to auxiliary graph 124, or by adding the edges of another graph with the same vertex set that has good expansion, which can be constructed randomly with high probability or via a deterministic construction such as a Ramanujan expander or another construction. Such constructions are standard in the art. Further, graph construction component 206 can identify a basis of short cycles of auxiliary graph 124. In various embodiments, graph construction component 206 can additionally add dummy vertices to thicken auxiliary graph 124 and decompose one or more cycles comprised in auxiliary graph 124 into one or more smaller cycles.

For example, assuming (without loss of generality) that the logical operator is an X-type (i.e., a Pauli X) operator, graph construction component 206 can begin construction of auxiliary graph 124 with a vertex for each qubit [symbol] in the support of logical operator 122. Thereafter, graph construction component 206 can add a (hyper) edge for each check having a Pauli Z or a Pauli Y support (i.e., locally anticommuting property) on [symbol] . Further, graph construction component 206 can add additional edges to increase the expansion of auxiliary graph 124. This can be achieved via randomized construction or another technique. Specifically, the additional edges can improve the edge expansion of auxiliary graph 124 at the cost of only a few additional qubits. In an embodiment, graph construction component 206 can also select a graph having a good expansion, wherein the graph can be randomized from a standard construction, and graph construction component 206 can combine the graph with auxiliary graph 124 to expand auxiliary graph 124. Herein, combining the graph with auxiliary graph 124 can imply taking the union of the edges without doubling the edges (i.e., adding the edges of another graph with the same vertex set and having good expansion to auxiliary graph 124), which can result in two graphs on the same vertex, wherein the first graph can be auxiliary graph 124 and the second graph can be the graph selected by graph construction component 206 and constructed via a pre-existing expander graph construction.

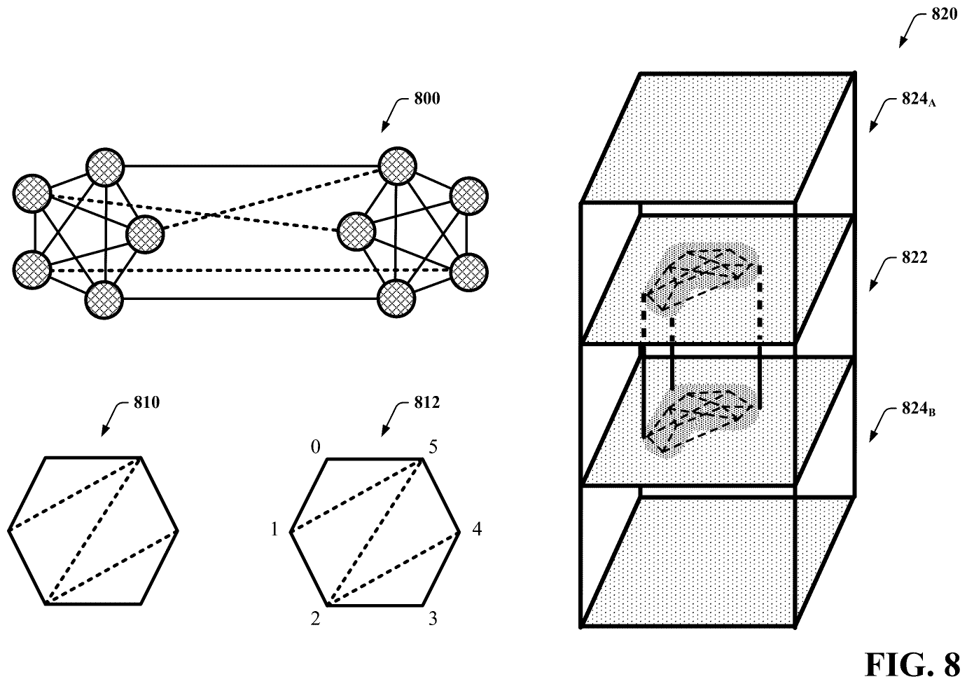

After adding the additional edges, graph construction component 206 can find a basis of short cycles of auxiliary graph 124 via cycle basis algorithms or the decongestion lemma in Appendix A of Freedman and Hastings (Freedman, M., & Hastings, M. B. (2021 May 24). Building manifolds from quantum codes. arXiv.org. https://arxiv.org/abs/2012.02249). For each cycle, graph construction component 206 can introduce a Z check on qubits on edges in the cycle and eliminate cycles that are redundant with checks in the code. Such redundancy can occur if the original code checks are overcomplete. In various embodiments, graph construction component 206 can add dummy vertices and thicken auxiliary graph 124 to spread out the cycle checks across layers, based on how congested the cycles are, additional aspects of which are described with reference to FIG. 8. For example, if a single edge is employed by too many cycles, it can be desirable to spread out the cycles over multiple layers. Further, graph construction component 206 can ensure that auxiliary graph 124 has a cycle basis of only short cycles (e.g., cycles having a length≤w for any choice of w≥3) by decomposing, via cellulation, cycles that are larger than a defined size. However, these additional steps can be eliminated for bivariate bicycles codes.

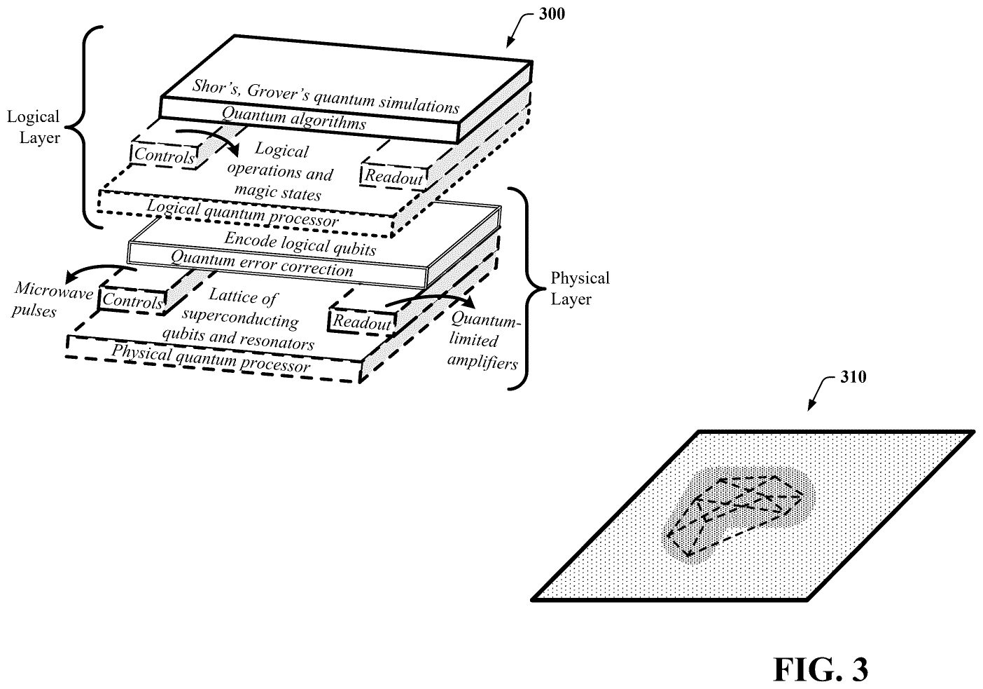

To ensure that an appropriate auxiliary graph (e.g., auxiliary graph 124) can be identified and employed in the measurement procedure, graph construction component 206 can begin construction of auxiliary graph 124 by generating the sum of a perfect matching on the qubits in the intersection of the support of logical operator 122 and the Y/Z support of checks overlapping logical operator 122. Next, graph construction component 206 can add the distinct edges of a random expanding graph to ensure the Cheeger constant is at least 1. To ensure a low-weight generating set of cycles, graph construction component 206 can then generate sufficiently many copies of auxiliary graph 124 with dummy vertices that do not support qubits and join the copied vertices together along lines. Finally, graph construction component 206 can sparsify one copy of each high-weight plaquette by adding extra edges to triangulate it in one of the layers. An existing result due to Freedman and Hastings (cited in paragraph [0088]) guarantees that this can be achieved with log²|V| layers and provides an algorithm to find the generating set of cycles. Additional details about auxiliary graph 124 are described with reference to FIG. 3.

FIG. 2 illustrates a block diagram of an example, non-limiting system 200 that can employ low-overhead fault-tolerant quantum computation to measure a logical operator in accordance with one or more embodiments described herein. Repetitive description of like elements and/or processes employed in respective embodiments is omitted for sake of brevity.

As described with reference to FIG. 1, logical operator gauging algorithm 110 can comprise graph selection component 202, measurement component 204, graph construction component 206 and code construction component 208. In this regard, non-limiting system 200 describes the system of logical operator gauging algorithm 110 (i.e., Algorithm 1 presented in FIG. 12) and quantum system 112 that can employ deformed quantum stabilizer code 126 to measure logical operator 122 via gauging.

Embodiments described herein provide a circuit construction that can generate low-overhead in some cases. For example, in various embodiments, logical operator gauging algorithm 110 can deform input quantum stabilizer code 120 via unitary circuits, followed by directly measuring out qubits in a logical operator. For example, logical operator gauging algorithm 110 can switch input quantum stabilizer code 120 to deformed quantum stabilizer code 126. By switching input quantum stabilizer code 120 into deformed quantum stabilizer code 126, one of the logical qubits of input quantum stabilizer code 120 can be measured. The switching can be performed by measuring (e.g., by measurement component 204) the check operators of deformed quantum stabilizer code 126. Logical operator gauging algorithm 110 can repeat the measurement for a number of cycles proportional to the code distance to achieve a desirable level of fault-tolerance for measurement of the logical operator. Upon completion of the measurement, logical operator gauging algorithm 110 can switch deformed quantum stabilizer code 126 back to input quantum stabilizer code 120 by measuring the check operators of input quantum stabilizer code 120.

FIG. 3 illustrates diagrams of example, non-limiting structures 300 and 310 associated with measurement of a logical operator in accordance with one or more embodiments described herein. Repetitive description of like elements and/or processes employed in respective embodiments is omitted for sake of brevity.

As stated elsewhere herein, embodiments of the present disclosure can be employed for logical measurements in quantum codes to solve problems that address the conversion of instructions from a logical processor into a fault-tolerant procedure via a quantum error-correcting code. Non-limiting structure 300 represents logical and physical layers of a quantum computing system and shows how a full stack of a quantum computer operates. The logical layer comprises algorithms, the theory of how the quantum computer can be expected to operate, etc. The physical layer comprises physical degrees of freedom that can be noisy and that can benefit from error correction. Such error correction can allow for the implementation of logical gates and logical operations, such that the logical gates and operations can generate satisfactory results even in the presence of noise. The various embodiments herein introduce a more flexible method of performing such logical gates and operations by providing a code/algorithm (e.g., logical operator gauging algorithm 110) that can protect the information processed and generated by such logical gates and operation. For example, to protect the information, logical operator gauging algorithm 110 can employ auxiliary graph 124, instead of relying on the structure of logical operator gauging algorithm 110, wherein auxiliary graph 124 can introduce flexibility in the measurements of logical operators. As described in one or more embodiments, this flexibility can reduce the cost associated with performing such measurements.

With continued reference to FIG. 1, non-limiting structure 310 represents auxiliary graph 124 (also known as auxiliary graph G or connected graph G). In various embodiments, auxiliary graph 124, input quantum stabilizer code 120 in the code state |Ψ [symbol] and logical operator 122 (also known as logical operator L) can be input to logical operator gauging algorithm 110. In various embodiments, logical operator gauging algorithm 110 can implement a gauging measurement procedure to measure logical operator 122. Measuring logical operator 122 can comprise measuring the qubits acted upon by logical operator 122. For example, measurement component 204 can apply a rotation to bring logical operator 122 in the form of a product of Pauli X matrices. Thereafter, graph selection component 202 can select auxiliary graph 124, wherein auxiliary graph 124 can be one of several auxiliary graphs that can be employed in the gauging measurement procedure. Auxiliary graph 124 can be a connected graph that can connect together the qubits associated with logical operator 122. Next, measurement component 204 can add ancillary (i.e., auxiliary) qubits to the edges of auxiliary graph 124 and perform measurements that can correlate the vertices of auxiliary graph 124 to the edges of auxiliary graph 124. For example, measurement component 204 can initialize an ancilla qubit in |0 [symbol] on each edge of auxiliary graph 124, measure Xᵥ [symbol] Xₑ on the vertices of auxiliary graph 124, and measure Zₑ on the edges of auxiliary graph 124. Finally, measurement component 204 can return the gauging measurement procedure to input quantum stabilizer code 120 by measuring the edges of auxiliary graph 124 to remove the edges, which can allow original operations to continue. The gauging measurement procedure upto this stage can be employed if measurement errors are not a concern during gauging measurement procedure.

However, to ensure fault-tolerance, measurement component 204 can additionally perform first repeated measurements of original checks for a first number of cycles and perform second repeated measurements of deformed checks for a second number of cycles, wherein an original check is a product of original Pauli matrices, and wherein a deformed check is a product of Pauli matrices based on original qubits and the respective auxiliary qubits. For example, measurement component 204 can perform repeated measurements of original checks for enough cycles to achieve a desired distance to measurement errors, before initializing the ancillary qubits and after measuring Zₑ on each edge of G. Additionally, measurement component 204 can perform a desirable number cycles of repeated measurements of deformed checks after measuring Xᵥ [symbol] Xₑ on each vertex of G and prior to measuring Zₑ on each edge of G. The measurements performed by measurement component 204 can produce the measurement outcome σ=±1 and the post-measurement code state

$$\frac{1}{2} ( 1 + σ L ) \vert Ψ 〉 .$$

Theorems 1 and 2 describe additional details associated with Algorithm 1.

Theorem 1 (Gauging measurement): The gauging procedure defined in Algorithm 1 is equivalent to performing a projective measurement of L.

Gauging measurement proof. Applying the gauging measurement to an initial state Ψ results in the state given by Equation 1 up to an overall normalization.

$${{\prod }_{v} \frac{1}{2} ( 1 + {ε}_{v} {A}_{v} ) \vert Ψ 〉 \vert 0 〉}_{E} \qquad Equation 1$$

Here, εᵥ represents the observed result of measuring the operator Aᵥ=Xᵥ [symbol] Xₑ and 0_{E}=0^{⊗E}. Ungauging by measuring out the edge degrees of freedom in the Z basis and discarding them results in the state given by Equation 2 up to an overall normalization.

$${{z}_{e} {\vert}_{E} {\prod }_{v} \frac{1}{2} ( 1 + {ε}_{v} {A}_{v} ) \vert Ψ 〉 \vert 0 〉}_{E} \qquad Equation 2$$

Here, zₑ_{_{E}}=⊗ₑzₑ_{ₑ} where zₑ represents the observed result of measuring the operator Zₑ. Next, the product of projection operators is expanded into a sum.

Given

$${z}_{{e}_{E}} \frac{1}{{2}^{V}} {\sum }_{c ∈ {C}^{0} ( G , {ℤ}_{2} )} ε ( c ) {X}_{V} ( c ) {X}_{E} ( δ c ) Ψ {0}_{E} ,$$

where the sum is over [symbol] -valued 0-cochains on G, Equations 2A-2C apply.

$$ε ( c ) = {\prod }_{v} {ε}_{v}^{{c}_{v}} , \qquad Equation 2 A$$

$${X}_{V} ( c ) = {\prod }_{v} {X}_{v}^{{c}_{v}} , \qquad Equation 2 B$$

$${X}_{E} ( δ c ) = {\prod }_{e} {X}_{e}^{{\{ δ c \}}_{e}} , \qquad Equation 2 C$$

and δ(⋅) is the cochain map that sends a 0-chain c on vertices to a 1-chain δc on edges. Since zₑ_{_{E}}X_{E}(δc)0_{E} is zero unless zₑ={δc}ₑ on all edges, we the ungauged state can be re-written as Equation 2D for a fixed c′ that satisfies δc′=z and Z⁰(G, [symbol] ₂), the group of 0-cocycles on G.

$$\frac{1}{{2}^{V}} {\sum }_{cs . t . δ c = z} ε ( c ) {X}_{V} ( c ) Ψ = \frac{1}{{2}^{V}} {X}_{V} ( {c}^{′} ) {\sum }_{c ∈ {Z}^{0} ( G , {ℤ}_{2} )} ε ( c ) {X}_{V} ( c ) Ψ \qquad Equation 2 D$$

For a connected graph G, there are only two elements c∈Z⁰(G, [symbol] ₂), either cᵥ=1 for all vertices, or cᵥ=0 for all vertices. Hence, the ungauged state is

$${X}_{V} ( {c}^{′} ) \frac{1}{2} ( 1 + σ L ) Ψ ,$$

where L=ΠᵥXᵥ is the logical operator being measured, and σ=Πᵥϵᵥ is the observed outcome of the logical measurement. Here, X_{V}(c′) is a Pauli byproduct operator determined by the observed measurement outcomes.

Remark 1: The gauging measurement procedure can be implemented by a circuit with no additional qubits by implementing the Ay measurements as follows. After initializing the edge qubits, the entangling circuit Πᵥ [symbol] CX_{v→e} can be executed. Next, Xᵥ can be projectively measured on all vertices in G, maintaining the post-measurement state. Thereafter, the same entangling circuit can be repeated followed by a measurement of the edge operators Zₑ where the edge qubits are discarded.

Remark 2 (Circuit implementation): Algorithm 1 can represent an extremely flexible recipe to measure the logical operator due to the choice of the arbitrary graph (i.e., auxiliary graph 124, auxiliary graph G, connected graph G). The properties of deformed quantum stabilizer code 126 can depend strongly on the choice of auxiliary graph 124. Discussed below are desirable properties of auxiliary graph 124 to achieve a fault-tolerant implementation of the gauging of the measurement of logical operator 122 with low-overhead. It should be noted that auxiliary graph 124 can be chosen to have additional vertices beyond the qubits in the support of a given logical operator. This can be achieved by adding (e.g., by measurement component 204) an auxiliary qubit, initialized in the +state, for each desired extra vertex, followed by gauging (e.g., by measurement component 204) the desired logical operator multiplied by X (i.e., Pauli X) on each added vertex. Such extra vertices are called dummy vertices since they have no effect on the gauging measurement because the dummy vertices return the +1 result with certainty when Xᵥ is measured on the dummy vertices. As a result, such vertices do not need to be included in the measurement of logical operator 122 in practice and can be substituted for the classical value +1.

Remark 3 (Desiderata for G): In various embodiments, graph selection component 202 can be employed to select the auxiliary graph G based on threefold goals, wherein the auxiliary graph G can be a constant-degree graph. First, G should contain a constant-length edge-path between pairs of vertices that are in the Z-type (i.e., Pauli Z) support of a check from the original code (i.e., input quantum stabilizer code 120). Second, the Cheeger constant of (should be at least 1, that is h(G)≥1 to ensure that G is sufficiently expanding. The Z-type support of a Pauli operator is the set of sites it acts on via Y and Z operators. Third, there should be a generating set of cycles for G with low-weight (less than some constant). When such an auxiliary graph is found, the gauging measurement procedure can have a constant qubit overhead.

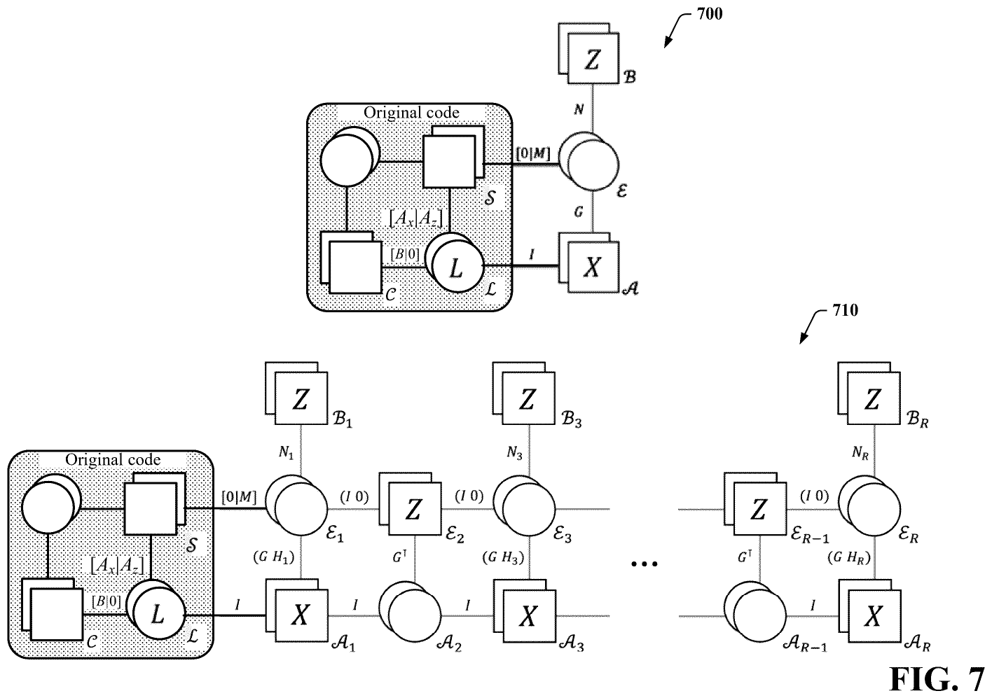

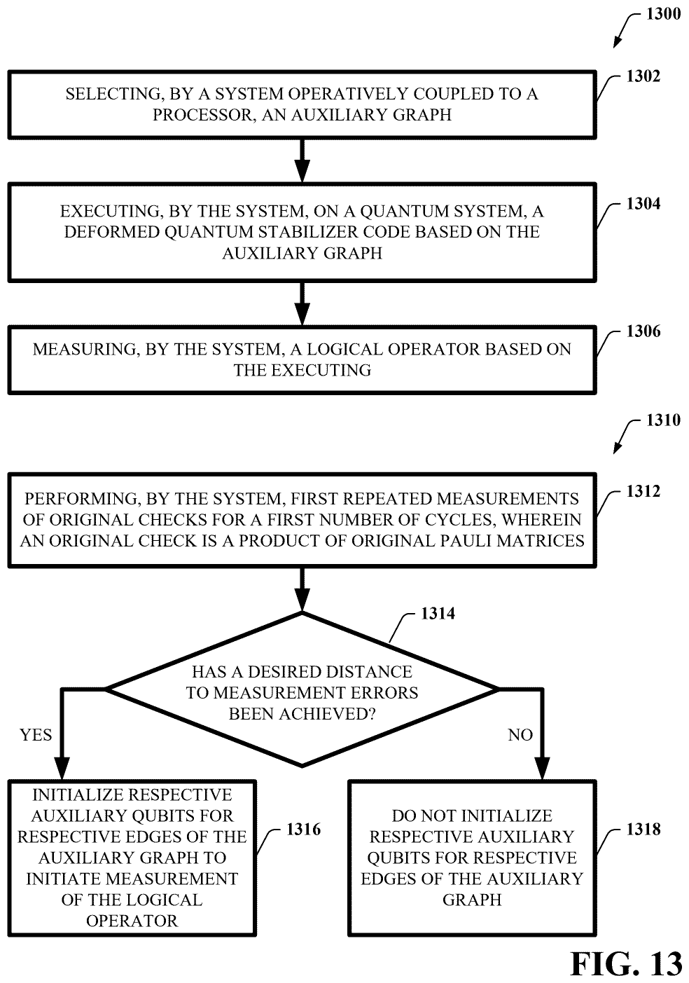

Remark 4 (Construction of a suitable G): An alternative approach can involve the construction of a graph G with qubit overhead O(W log² W) that satisfies the desiderata from the previous remark. First, a [symbol] ₂-perfect-matching of the vertices in the Z-type support of each check from the original code that overlaps the target logical operator L can be selected, and an edge can be added (e.g., by measurement component 204) to G for each pair of matched vertices. Next, edges can be added (e.g., by measurement component 204) to G until h(G)≥1. This step can be performed by adding edges to G at random while preserving a constant degree, or by taking an existing constant degree expander graph with h(G)≥1 and adding its edges to G. Further, G₀ can be used to denote the graph that has been constructed thus far. Thereafter, a sufficient number of additional layers that are copies of the graph G₀ on a sequence of dummy vertices can be added to G, which are connected sequentially back to the original vertices. Next, edges can be added to the additional layers to sparsify the cycles of G₀ to achieve a desired constant weight and degree. This step is based on cellulation and the Freedman-Hastings decongestion lemma (referenced in paragraph [0088]), and is explained in detail in the sections following the discussion for FIG. 13. The Freedman-Hastings decongestion lemma can establishes a log² W upper bound on the number of layers needed to sparsify the cycles of an arbitrary constant degree graph G with W vertices when following this procedure. The lemma comes with an efficient algorithm to construct a sparsified basis of cycles, given a constant degree graph. FIG. 7 illustrates a depiction of the deformed code after these steps.

Remark 5 (Parallelization): The gauging measurement procedure can be applied to an arbitrary number of logical operators in parallel, provided that no pair of these logical operators act on a common qubit via different nontrivial Pauli operators. To maintain an LDPC code during the code deformation step, only a constant number of logical operators being measured can share support on any single qubit. For codes that support many disjoint logical representatives, this offers the potential of performing highly parallelized logical gates. It is also possible to trade-off time overhead for space overhead by performing 2m−1 measurements of equivalent logical operators in parallel for d/m cycles followed by taking a majority vote to determine the classical outcome of the logical measurement.

Remark 6 (Generalizations): The gauging measurement procedure described herein can be vastly generalized. For example, the gauging measurement procedure can be applied to any representation of a finite group by operators that have a tensor product factorization. Such a representation need not form the logical operators of a quantum error-correcting code. This includes non-Pauli operators whose measurements can produce magic states. One example is the measurement of Clifford operators in a topological code (as given by M. Davydova et al.). The generalization can be extended to qubit systems and non-abelian groups. However, for non-abelian groups a definite global charge is not fixed by measuring the charge locally.

Remark 7 (Replacing G with a hypergraph): Alternatively, the gauging measurement procedure can also be generalized to measure a number of operators simultaneously. For example, the gauging measurement procedure can be applied to measure any abelian group of operators that can be described as the X-type operators that commute with an auxiliary set of k-local Z-type checks. This type of group can equivalently be formulated as the kernel of a sparse linear map over [symbol] ₚ by employing the stabilizer formalism (D. E. Gottesman, Stabilizer Codes and Quantum Error Correction, Ph.D. thesis, California Institute of Technology (1997)). For qubits, this is equivalent to replacing G with a hypergraph. This generalized gauging procedure can perform a code deformation by introducing a qubit for each hyperedge and measuring into new Aᵥ checks given by the product of X on a vertex and the adjacent hyperedges.

### Fault-Tolerant Implementation:

Algorithm 1 can be implemented fault tolerantly by measuring (e.g., by measurement component 204) the stabilizer checks of the original code (i.e., input quantum stabilizer code 120) for d cycles, followed by measuring (e.g., by measurement component 204) the checks of the deformed code (i.e., deformed quantum stabilizer code 126) for d cycles, and finally measuring (e.g., by measurement component 204) the checks of the original code for a further d cycles.

Theorem 2 (Fault-tolerance): The fault-tolerant implementation of Algorithm 1 with a suitable graph has spacetime fault distance d.

Proof. The proof follows several lemmas that are stated and proven (presented after the description for FIG. 13). The argument can be structured as follows. The fault distance can be shown to be lower bounded by the minimum of the space fault distance and the time fault distance. The time fault distance can be lower bounded by the number of cycles between the start and end of the code deformation, which is chosen to be d. The space fault distance can be lower bounded by the distance of the original code multiplied by min(1, h(G)), because any logical operator in the deformed quantum stabilizer code (i.e., deformed quantum stabilizer code 126) can be cleaned such that it can define a logical operator of the input quantum stabilizer code (e.g., input quantum stabilizer code 120). The distance reduction of the cleaning can be determined by the connectivity of G.

Remark 8: The scaling of the fault distance can hold even if the Bₚ checks are measured much less often than the Aᵥ and \tilde{s}ⱼ checks. In fact, in one or more embodiments, the direct measurement of the Bₚ checks can be completely avoided because the Bₚ checks can be inferred from the initialization and readout steps of the code deformation. While this is appealing in cases where the Bₚ checks have high weight, it can result in large detector cells. Hence, the code is not expected to have a threshold without further modification. However, in practice, this strategy can prove useful for small instances.

Remark 9: The d cycles of quantum error correction in the original code before and after the gauging measurement are for the purposes of establishing a proof and are extraneous in practice. In a full fault-tolerant computation, the number of cycles before and after a measurement can depend on the surrounding operations. If gauging measurement occurs in the middle of a large computation, a constant number of cycles before and after can be expected to suffice to ensure fault tolerance. However, this choice can affect the distance and threshold depending on the surrounding operations.

Remark 10: The circuit implementation introduced in Remark 1 can lead to a different, but closely related, fault-tolerant implementation where the vertex qubits are decoupled and can be discarded during the deformation. The main difference is that the fault-tolerant implementation can lead to a reduction in the distance by a constant multiple. However, the distance reduction can be avoided by adding an extra dummy vertex to divide each edge into a pair of edges.

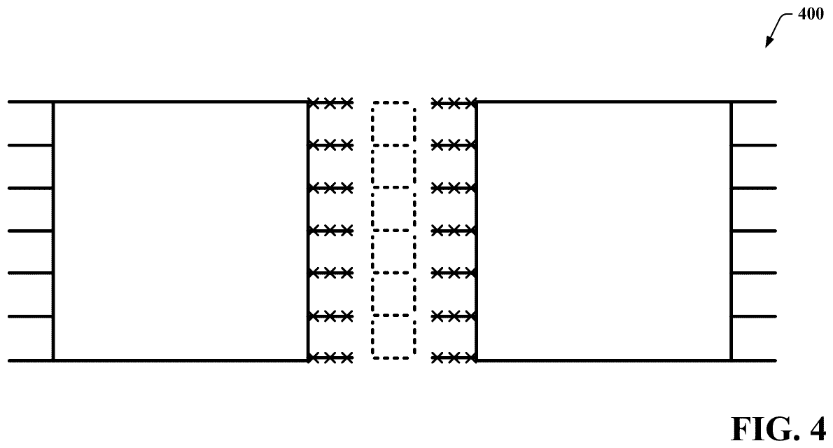

FIG. 4 illustrates a diagram of example, non-limiting representation 400 of an auxiliary graph employed as a ladder between surface codes in accordance with one or more embodiments described herein. Repetitive description of like elements and/or processes employed in respective embodiments is omitted for sake of brevity.

With continued reference to the embodiments of FIGS. 1 and 2, applying the gauging measurement procedure to a product of X-type logicals on a pair of surface codes (edges marked by the ‘x’ symbol in FIG. 4) and choosing the graph G to be a ladder (edges illustrated by the dashed lines) can result in a standard surface code lattice surgery procedure.

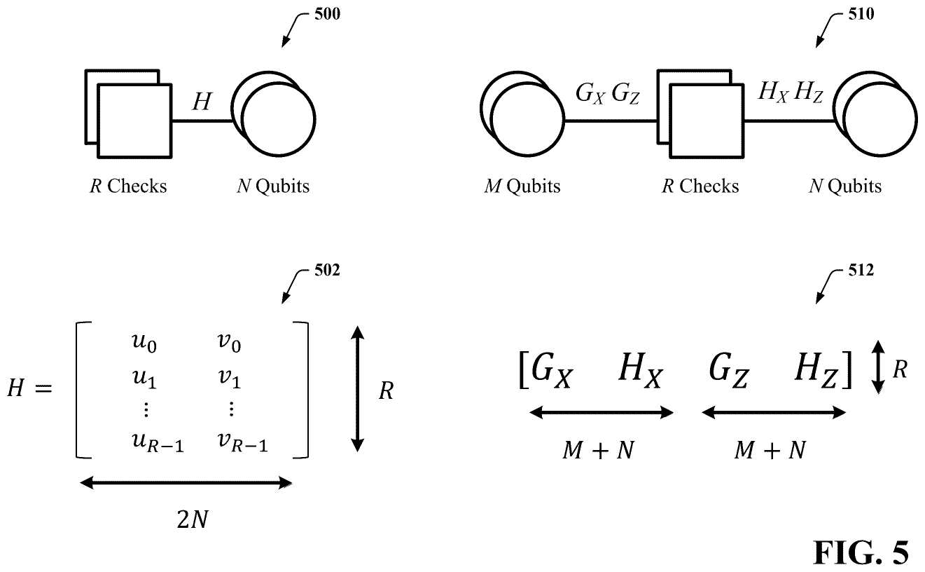

FIG. 5 illustrates diagrams of example, non-limiting tanner graphs 500 and 510 and matrices 502 and 512 associated with measurement of a logical operator in accordance with one or more embodiments described herein. Repetitive description of like elements and/or processes employed in respective embodiments is omitted for sake of brevity.

The gauging measurement procedure discussed with reference to at least FIGS. 1-3 can be described in multiple ways. In various embodiments, the gauging measurement procedure can begin with input quantum stabilizer code 120 (i.e., the original code). For example, given input quantum stabilizer code 120, measurement component 204 can identify a logical operator (e.g., logical operator 122) to be measured, which can involve the measurement of a qubit. In FIG. 5, input quantum stabilizer code 120 is represented by non-limiting tanner graph 500 of FIG. 5.

In non-limiting tanner graph 500 and non-limiting tanner graph 510, the square boxes represent parity checks that are connected to the qubits on which the parity checks are enacted during the gauging measurement procedure. The checks can be bundled with other checks, and the qubits can be bundled with other qubits. The connections between the check bundles and the qubit bundles can be specified by a binary matrix, such as non-limiting matrix 502. Non-limiting matrix 502 can comprise a first entry in position ij if the i^{th} check is connected to the j^{th} qubit. Accordingly, row j of non-limiting matrix 502 indicates that Sⱼ=i^{u}j^{·vj}X(uⱼ)Z(vⱼ) is a check (also known as, a stabilizer), where

$$X ( {u}_{i} ) = {\prod }_{q = 0}^{N - 1} {X}_{q}^{{u}_{i} [ q ]} and Z ( {v}_{i} ) = {\prod }_{q = 0}^{N - 1} {Z}_{q}^{{v}_{i} [ q ]} .$$

By generalizing further, the matrix can be allowed to have X and Z parts, as illustrated by non-limiting matrix 512. With reference to non-limiting matrix 512, checks connected to more than one bundle of qubits can more generally indicate a check matrix.

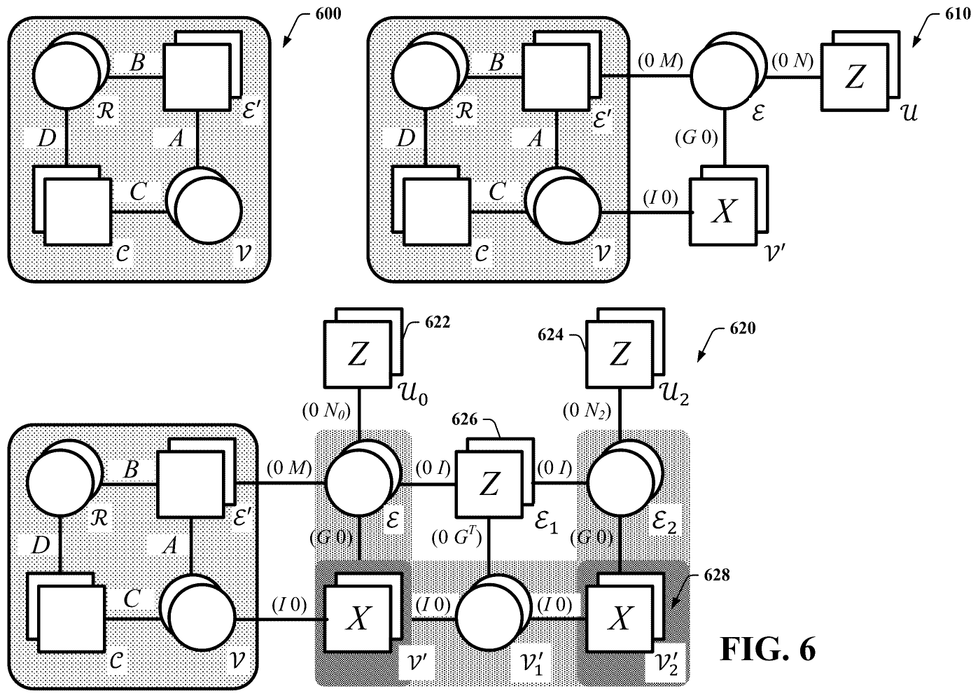

FIG. 6 illustrates diagrams of example, non-limiting tanner graphs 600, 610 and 620 that can be employed to measure a logical operator in accordance with one or more embodiments described herein. Repetitive description of like elements and/or processes employed in respective embodiments is omitted for sake of brevity.

As discussed with reference to at least FIG. 1-3, graph selection component 202 can identify, during the gauging measurement procedure, the qubit support [symbol] of the logical operator L (i.e., logical operator 122) to be measured. The support [symbol] of the logical operator L can be placed on the set of qubits of [symbol] . Adjacently, there can exist some checks [symbol] ′ that can anticommute locally with L. Checks [symbol] ′ can represent the checks that can act as Pauli Z supports on the qubits in [symbol] where the X logical operator is located. Checks [symbol] ′ can be different from the set of checks C. Some of these checks can be modified by the construction of deformed quantum stabilizer code 126, whereas some other checks can remain unmodified. In one or more embodiments, graph selection component 202 can specify matrices A, B, C and D as submatrices of the matrix H to generate non-limiting tanner graph 600. Thus, non-limiting tanner graph 600 can be a representation of input quantum stabilizer code 120 based on non-limiting tanner graph 500 of FIG. 5. The additional qubits and checks introduced during the gauging measurement procedure are illustrated on the right-hand side and outside of the patterned box in non-limiting tanner graph 610. The connectivity of the new X checks that are introduced and that of the other connections can depend on the auxiliary graph G. Thereafter, graph selection component 202 can randomly choose a connected graph by providing its incidence matrix G, which has |V| rows, | [symbol] | columns, and Gᵥₑ=1 if edge e contains vertex v.

Next, deformed quantum stabilizer code 126 can be defined by code construction component 208. Finally, logical operator L can be measured on a quantum computer (e.g., quantum system 112). For example, measurement component 204 can measure checks of deformed quantum stabilizer code 126 for T cycles. That is, measurement component 204 can switch input quantum stabilizer code 120 into deformed quantum stabilizer code 126 for T number of code cycles until measurement component 204 can determine that logical operator L has been measured. Thereafter, measurement component 204 can switch deformed quantum stabilizer code 126 back to input quantum stabilizer code 120 by measuring the newly added qubits.

As described elsewhere herein, code construction component 208 can construct deformed quantum stabilizer code 126 via min-weight perfect matching based on auxiliary graph 124 and checks of input quantum stabilizer code 120, such that deformed quantum stabilizer code 126 can comprise auxiliary graph 124 and one or more auxiliary qubits. That is, deformed quantum stabilizer code 126 can correspond to an expanded version of auxiliary graph 124. For example, to define deformed quantum stabilizer code 126, code construction component 208 can construct M (a matching) via min-weight-perfect-matching or another type of perfect matching given A and G. This can ensure that checks in [symbol] ′ and [symbol] ′ commute, and checks in [symbol] ′ are minimal weight. Additionally, code construction component 208 can find, via Gaussian elimination, a matrix N (a cycle basis of auxiliary graph G) whose rows span the row null space of G. This can ensure that checks in [symbol] ′ and [symbol] commute, and deformed quantum stabilizer code 126 has k−1 logical qubits if input quantum stabilizer code 120 has k logical qubits. Non-limiting tanner graph 610 represents deformed quantum stabilizer code 126, wherein I is the | [symbol] |×| [symbol] | identity matrix and | [symbol] ′|=| [symbol] |. Thus, auxiliary graph 124 can be completely specified up to the choice of cycle bases or up to I or II.

The construction described herein can generate a graph with qubits and check degrees that grow with the code size, which is not ideal for implementation. Thus, in various embodiments, thickening can be performed by graph construction component 206 to generate a larger graph extended by dummy vertices. Dummy vertices can be vertices that are not connected directly to input quantum stabilizer code 120, such as the vertex illustrated at 628. The amount of thickening can depend on the decongestion lemma of Freedman and Hastings (cited in paragraph [0088]). Based on the decongestion lemma, O(log²| [symbol] |) layers can be added going from the left-hand side to the right-hand side of non-limiting tanner graph 600. For example, in various embodiments, graph construction component 206 can also add additional layers, as desired, to non-limiting tanner graph 600 to thicken non-limiting tanner graph 600. The additional layers can ensure that the qubits and check degree are small enough, so that the graph is more ideal for practical implementation. Further, graph construction component 206 can spread the cycles of auxiliary graph 124 over multiple layers, as illustrated at 622 and 624. In FIG. 6, the thickened graph is illustrated as non-limiting tanner graph 620, with the extended portion illustrated on the right-hand side. Vertex 626 can correspond to short cycles of auxiliary graph 124 in the right-hand side portion of non-limiting tanner graph 620. It should be noted that in non-limiting tanner graph 620, N=(N₀|N₂| . . . ) represents the null space of auxiliary graph 124.

The graph thickening described herein can be applicable in scenarios where graph selection component 202 can randomly select auxiliary graph 124 for the gauging measurement procedure. On the contrary, auxiliary graph 124 can also be constructed by graph construction component 206, as described in one or more embodiments. That is, in one embodiment, graph selection component 202 can select auxiliary graph 124 defined by input quantum stabilizer code 120, and measurement component 204 can perform min-weight perfect matching based on auxiliary graph 124 to manipulate the construction of auxiliary graph 124. In another embodiment, auxiliary graph 124 can be constructed by graph construction component 206, as described with reference to FIG. 1.

FIG. 7 illustrates diagrams of example, non-limiting tanner graphs 700 and 710 that can be employed to measure a logical operator in accordance with one or more embodiments described herein. Repetitive description of like elements and/or processes employed in respective embodiments is omitted for sake of brevity.

With reference to at least FIGS. 1 and 6, in one or more embodiments, the tanner graphs associated with deformed quantum stabilizer code 126 can also be illustrated by non-limiting tanner graphs 700 and 710.

For example, non-limiting tanner graph 700 illustrates the tanner graph of deformed quantum stabilizer code 126. Non-limiting tanner graph 700 can also be represented compactly by creating ordered subsets of qubits (circles) and checks (squares) of X, Z, or mixed (unlabeled) type. As illustrated in FIG. 7, each edge connecting an X or a Z check set [symbol] and qubit set [symbol] is labeled by a binary matrix H with | [symbol] | rows and | [symbol] | columns, where Hᵢⱼ=1 if and only if the i^{th} check in [symbol] acts non-trivially on the j^{th} qubit in [symbol] . Edges from mixed type check sets are instead labeled with a symplectic matrix [H_{X}|H_{Z}] where H_{X} indicates qubits acted on by X, and H_{Z} represents qubits acted on by Z. The original code may not be CSS, but an assumption can be made (without loss of generality) that L, the operator being measured is X-type and its qubit support is L. Set [symbol] contains checks of input quantum stabilizer code 120 that do not have a Z-type support on L, whereas set [symbol] contains checks that do. Additionally, [symbol] is the set of Gauss's law operators Aᵥ, [symbol] is the set of flux operators Bₚ, and [symbol] is the set of edge qubits. Matrix N can specify a cycle basis of G, and M can indicate how original stabilizers are deformed by perfect matching in G (see Remark 4).

Non-limiting tanner graph 710 illustrates the tanner graph of the complete construction including decongestion and cellulation to guarantee that deformed quantum stabilizer code 126 is LDPC. Non-limiting tanner graph 710 employs the same notations as those employed by non-limiting tanner graph 700. Additionally, (B₁B₂) indicates a block matrix constructed from submatrices B₁ and B₁. Block matrices have been employed where qubits of the left block are those added to edges of the expanding auxiliary graph G, and qubits of the right block are those added to cellulate cycles. Depending on the layer i=1, 2, . . . , R, this cellulation can be applied to different elements of the cycle basis of G. Using R=O(log² W) layers can ensure that deformed quantum stabilizer code 126 is LDPC by the decongestion lemma of Freedman and Hastings (cited in paragraph [0088]).

FIG. 8 illustrates diagrams of example, non-limiting graph structures 800, 810, 812 and 820 associated with measurement of a logical operator in accordance with one or more embodiments described herein. Repetitive description of like elements and/or processes employed in respective embodiments is omitted for sake of brevity.

Non-limiting graph structures 800 and 810 are intended to describe additional aspects of constructing auxiliary graph 124, whereas non-limiting graph structure 820 is intended to describe additional characteristics of deformed quantum stabilizer code 126.

As stated with reference to FIG. 1, graph construction component 206 can construct auxiliary graph 124. Recall that graph construction component 206 can improve the edge expansion of auxiliary graph 124 by adding edges, and graph construction component 206 can decompose large cycles in auxiliary graph 124 to ensure that auxiliary graph 124 comprises only short cycles. In this regard, non-limiting graph structure 800 can represent an expanded portion of auxiliary graph 124, and the dashed lines can represent edges added by graph construction component 206. The expansion of a set of vertices can be represented by the number of edges leaving (i.e., travelling away from) that set of vertices. Counting the number of such edges over all sets of vertices and considering the minimum number of edges can represent the expansion of auxiliary graph 124. Adding more edges can increase the expansion quantity of auxiliary graph 124, and it is desirable for the expansion quantity to be large so that deformed quantum stabilizer code 126 corresponding to the expanded form of auxiliary graph 124 does not lost any code distance. That is, a higher expansion quantity can ensure that deformed quantum stabilizer code 126 is just as effective at error correction as input quantum stabilizer code 120. Further, non-limiting graph structure 810 can represent a large cycle in auxiliary graph 124 that can be decomposed into a smaller cycle by adding the edge represented by the dashed lines. Similarly, non-limiting graph structure 812 can represent cellulation of a weight-six cycle (edges illustrated by the solid lines) into a union of triangles by adding additional edges (dashed lines).

In various embodiments, employing deformed quantum stabilizer code 126 to measure logical operator 122 can maintain a fault distance associated with logical operator 122 below a defined threshold because deformed quantum stabilizer code 126 can be fault-tolerant. Deformed quantum stabilizer code 126 can be fault-tolerant because deformed quantum stabilizer code 126 can comprise dressed original checks, new star-X checks and new plaquette Z-checks (represented by the numeral 822). In various embodiments, it is demonstrated that qubit and measurement errors can be treated separately for a lower bound on the fault distance. The X-component of logical operator 122 can be cleaned onto vertices up to a Cheeger constant of G, the Z-component of logical operator 122 on edges can form strings that end on Z/Y-operators on vertices, and after cleaning, the restriction of logical operator 122 to vertices is a logical operator of the undeformed code. As far as measurement errors are concerned, d cycles of repeated check measurement at each step (represented by numerals 824_{A} and 824_{B}), except optionally for plaquette checks, can be performed. This can make the measurement error distance d as it catches syndromes that hide during the deformation.

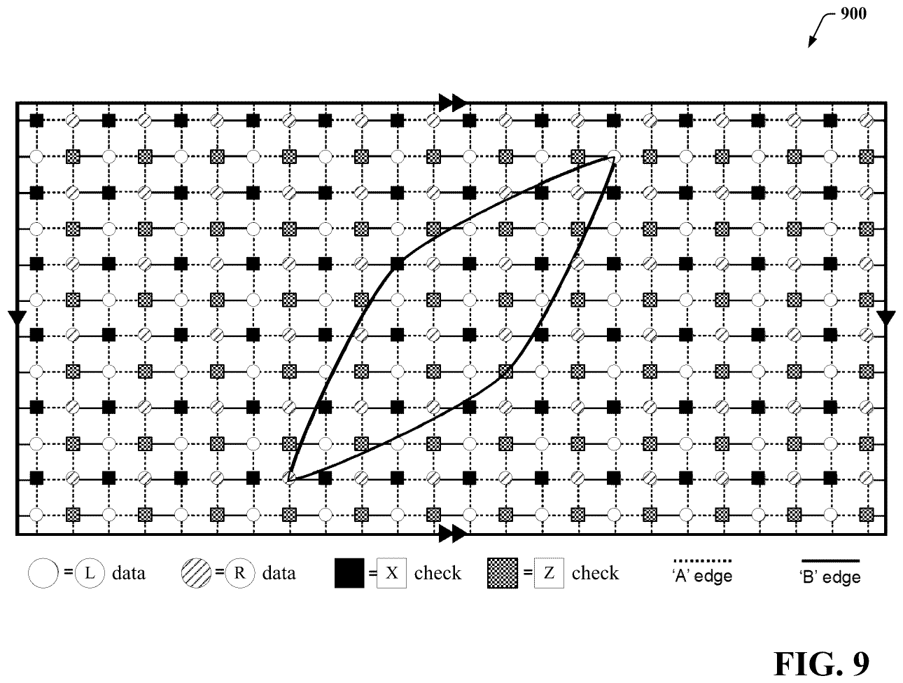

FIGS. 9-11 illustrate practical implementations of the various embodiments described herein. A further discussion related to the examples discussed with reference to FIGS. 9-11 is provided in the sections after the discussion for FIG. 13.

FIG. 9 illustrates a diagram of an example, non-limiting tanner graph 900 of a Bivariate Bicycle Code in accordance with one or more embodiments described herein. Repetitive description of like elements and/or processes employed in respective embodiments is omitted for sake of brevity.

Non-limiting tanner graph 900 is a tanner graph of the exemplary gross code or BBC code [symbol] 144,12,12 [symbol] (e.g., input quantum stabilizer code 120). Non-limiting tanner graph 900 has been drawn on a torus by identifying left/right sides and top/bottom sides. Some example long-range edges are also shown. Such long-range edges can be translated across the lattice to obtain all such edges. All qubits are degree-6.

In one or more embodiments, X̅=X(f,0) represents a logical operator that acts on L qubits indicated by terms in f (given by Equation 3) and not on R qubits. Both L and R qubits can be labelled by monomials x^{a}y^{b}, and additional qubits and checks can be denoted by N_{f}. In one or more embodiments, non-limiting tanner graph 900 can be employed to measure the logical operator X̅.

$$f = 1 + x + {x}^{2} + {x}^{3} + {x}^{6} + {x}^{7} + {x}^{8} + {x}^{9} + {y}^{3} ( x + {x}^{5} + {x}^{7} + {x}^{11} ) . \qquad Equation 3$$

The gauging construction described in various embodiments herein can offer more flexibility to reduce overhead. As such, only N_{f}=41 (according to Equation 4) additional qubits and checks can be employed to measure X̅.

$${N}_{f} = \vert {𝒱}^{′} \vert + \vert ℰ \vert + \vert 𝒰 \vert = 12 + 22 + 7 = 41 \qquad Equation 4$$

On the contrary, by employing existing constructions, X̅ cannot be measured satisfactorily (i.e. with code distance d and low-overhead). For example, the general approach employed by an existing technique suggests a 23-layer ancilla system (N_{f}=690). Another existing technique employs a 5-layer ancilla system (N_{f}=150). Yet another existing technique involves the measurement of an alternative logical with higher weight, and 1 (larger) layer ancilla system (N_{f}=45).

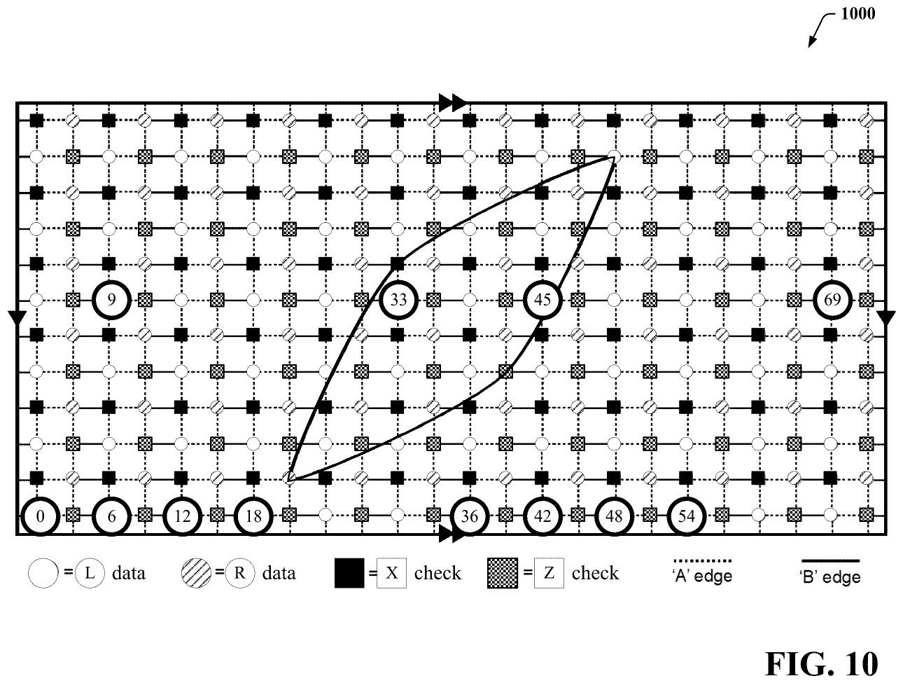

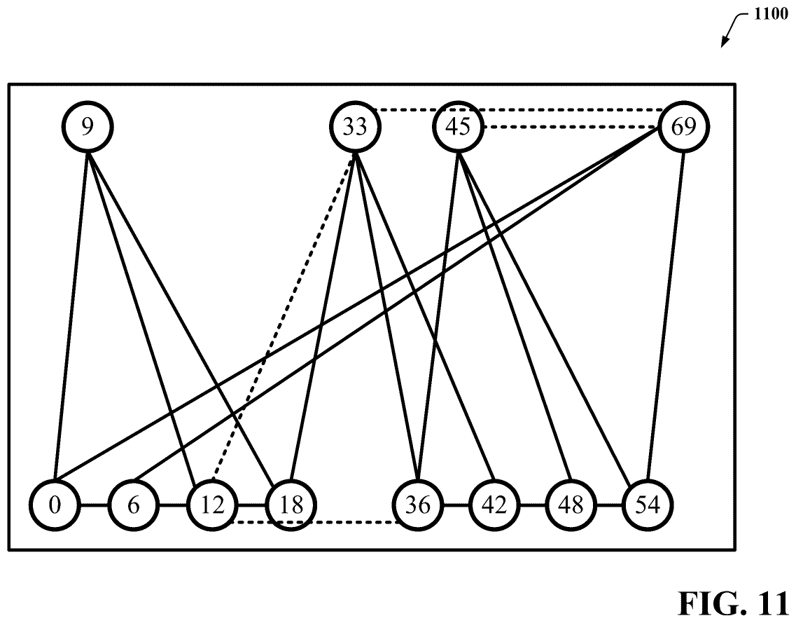

FIG. 10 illustrates a diagram of an example, non-limiting tanner graph 1000 based on the bivariate bicycle code for FIG. 9, and FIG. 11 illustrates a diagram of an example, non-limiting auxiliary graph 1100 associated with the bivariate bicycle code for FIG. 9 in accordance with one or more embodiments described herein. Repetitive description of like elements and/or processes employed in respective embodiments is omitted for sake of brevity.

Based on non-limiting tanner graph 1000, graph selection component 202 can select/choose an auxiliary graph G (e.g., non-limiting auxiliary graph 1100, auxiliary graph 124) that can include an edge for each adjacent Z check and some additional edges (illustrated by the dashed lines in FIG. 11). The corresponding deformed quantum stabilizer code (e.g., deformed quantum stabilizer code 126) can comprise low-weight checks and low qubit degrees, provided graph selection component 202 selects the lowest weight basis of gauge checks [symbol] . In the general notation of {d: count of degree d objects}, the check weights and qubits degrees can be as follows.

X check weights: {4:7, 5:2, 6:75}
Z check weights: {3:5, 4:2, 6:54, 7:18}
Qubit X degrees: {2:22, 3:132, 4:12}
Qubit Z degrees: {1:8, 2:9, 3:149}
Qubit degrees: {3:8, 4:9, 5:5, 6:132, 7:12}

In non-limiting auxiliary graph 1100, the nodes illustrated by the numbered circles represent X checks that connect 1-to-1 to nodes illustrated by the numbered circles in non-limiting tanner graph 1000. The solid lines represent qubits connected 1-to-1 to adjacent Z checks in the original gross code, and the dashed lines represent qubits not connected to Z checks in the original gross code. The dashed lines exist to ensure a good code distance for deformed quantum stabilizer code 126.

### ADDITIONAL EXAMPLES

Embodiments of the present disclosure can also be applied to half gross codes such as [symbol] 72,12,6 [symbol] and double gross codes such as [symbol] 288,12,18 [symbol] .

For example, in one or more embodiments, the logical operator X(f,0) can be measured (e.g., by measurement component 204) given the half gross code [symbol] 72,12,6 [symbol] (e.g., input quantum stabilizer code 120), wherein f can be given by Equation 5. X(f,0) can be a 72 qubit (72q) code logical operator that can be measured with many additional qubits and checks. For example, X(f,0) can be measured with 19 additional qubits and checks (9 qubits+6 X checks+4 Z checks=19).

$$f = {y}^{2} + {y}^{5} + {xy}^{2} + {x}^{2} {y}^{2} + {x}^{4} {y}^{5} + {x}^{5} {y}^{2} \qquad Equation 5$$

In the general notation of {d: count of degree d objects}, the check weights and qubits degrees can be as follows.

X check weights: {4:6, 6:36}
Z check weights: {3:2, 4:2, 6:27, 7:9}
Qubit X degrees: {2:9, 3:66, 4:6}
Qubit Z degrees: {2:4, 3:77}
Qubit degrees: {4:4, 5:5, 6:66, 7:6}

Similarly, in one or more embodiments, the logical operator Z(g,h) can be measured (e.g., by measurement component 204) given the half gross code [symbol] 72,12,6 [symbol] (e.g., input quantum stabilizer code 120), wherein g and h can be given by Equations 6 and 7, respectively. Z(g,h) can also be a 72 qubit (72q) code logical operator that can be measured with many additional qubits and checks. For example, Z(g,h) can be measured with 19 additional qubits and checks (9 qubits+4 X checks+6 Z checks=19).

$$g = {xy}^{4} + {x}^{3} + {x}^{5} {y}^{2} \qquad Equation 6$$

$$h = x + {x}^{3} {y}^{2} + {x}^{5} {y}^{4} \qquad Equation 7$$

In the general notation of {d: count of degree d objects}, the check weights and qubits degrees can be as follows.

X check weights: {4:4, 6:27, 7:9}
Z check weights: {4:6, 6:36}
Qubit X degrees: {2:4, 3:75, 4:2}
Qubit Z degrees: {2:9, 3:66, 4:6}
Qubit degrees: {4:4, 5:3, 6:68, 7:6}

In one or more embodiments, the logical operator X(f,0) can be measured (e.g., by measurement component 204) given the double gross code [symbol] 288,12,18 [symbol] (e.g., input quantum stabilizer code 120), wherein f can be given by Equation 8. Here, X(f, 0) can be a 288 qubit (288q) code logical operator that can be measured with many additional qubits and checks. For example, X(f, 0) can be measured with 65 additional qubits and checks (34 qubits+18 X checks+13 Z checks=65).

$$f = {y}^{4} + {y}^{7} + {xy}^{4} + {x}^{2} {y}^{4} + {x}^{4} y + {x}^{5} {y}^{10} + {x}^{6} ( {y}^{7} + {y}^{10} ) + {x}^{7} {y}^{4} + {x}^{8} ( y + {y}^{4} + {y}^{7} ) + {x}^{9} ( {y}^{4} + {y}^{10} ) + {x}^{10} ( {y}^{4} + {y}^{7} + {y}^{10} ) + {x}^{11} {y}^{4} \qquad Equation 8$$

In the general notation of {d: count of degree d objects}, the check weights and qubits degrees can be as follows.

X check weights: {4:7, 5:8, 6:147}
Z check weights: {2:1, 3:4, 5:3, 6:121, 7:28}
Qubit X degrees: {2:34, 3:270, 4:18}
Qubit Z degrees: {1:2, 2:18, 3:298, 4:1, 5:3}
Qubit degrees: {3:2, 4:18, 5:10, 6:271, 7:21}

FIG. 12 illustrates an example, non-limiting logical operator gauging algorithm 1200 in accordance with one or more embodiments described herein. Repetitive description of like elements and/or processes employed in respective embodiments is omitted for sake of brevity.

Non-limiting logical operator gauging algorithm 1200 (Algorithm 1) is a formal representation of the measurement gauging procedure described in various embodiments herein to measure a logical operator, such as logical operator 122. As such, non-limiting logical operator gauging algorithm 1200 can be analogous to logical operator gauging algorithm 110.

FIG. 13 illustrates flow diagrams of example, non-limiting method 1300 and 1310 that can employ low-overhead fault-tolerant quantum computation to measure a logical operator in accordance with one or more embodiments described herein. Repetitive description of like elements and/or processes employed in respective embodiments is omitted for sake of brevity.

At 1302, non-limiting method 1300 can comprise selecting (e.g., by graph selection component 202), by a system operatively coupled to a processor, an auxiliary graph.

At 1304, non-limiting method 1300 can comprise executing (e.g., by measurement component 204), by the system, on a quantum system, a deformed quantum stabilizer code based on the auxiliary graph.

At 1306, non-limiting method 1300 can comprise measuring (e.g., by measurement component 204), by the system, a logical operator based on the executing.

Measuring the logical operator can comprise initializing auxiliary qubits for respective edges of the auxiliary graph prior to measurement of the logical operator.

For example, at 1312, non-limiting method 1300 can comprise performing (e.g., by measurement component 204), by the system, first repeated measurements of original checks for a first number of cycles, wherein an original check is a product of original Pauli matrices.

At 1314, non-limiting method 1300 can comprise determining (e.g., by measurement component 204), by the system, whether a desired distance to measurement errors has been achieved.

If yes, then at 1316, non-limiting method 1300 can comprise initializing (e.g., by measurement component 204), respective auxiliary qubits for respective edges of the auxiliary graph to initiate measurement of the logical operator.

If not, then at 1318, respective auxiliary qubits for respective edges of the auxiliary graph are not initialized (e.g., by measurement component 204).

In various embodiments, non-limiting method 1300 can further comprise performing (e.g., by measurement component 204), by the system, second repeated measurements of deformed checks for a second number of cycles, wherein a deformed check is a product of Pauli matrices based on original qubits and the respective auxiliary qubits. The first repeated measurements and second repeated measurements can be performed to ensure fault-tolerant quantum computations.

The following sections further describe the details of the embodiments discussed herein and present the lemmas and proofs previously referenced.

### Relation to Previous Work:

Quantum error-correcting codes are an essential ingredient to protecting quantum information in a quantum computer from errors due to coupling to an external environment. Recent progress has led to the discovery of good qLDPC codes that have code parameters that can scale optimally with the number of physical qubits [[n, Θ(n), Θ(n)]]. Such qLDPC codes are far more efficient at protecting large amounts of quantum information than standard approaches based on surface codes. However, the advantages that good LDPC codes offer for quantum information storage appear to come at the cost of straightforward and efficient logical quantum information processing.

Fault tolerance is key for logical quantum gates on a quantum error-correcting code, that is, the function in the presence of errors while maintaining protection of the encoded quantum information throughout a computation. Existing approaches to performing fault-tolerant logical quantum gates can be roughly divided into code-preserving and code-deforming. Code-preserving gates include transversal gates that act via the same operator on all physical and logical qubits, and more general locality-preserving gates. Here, the definition of locality depends on the context, and a loose notion is that the set of constant weight errors should be preserved. Nontrivial code-preserving gates are synonymous with symmetries of an underlying code. As a consequence, such gates necessitate a degree of structure to exist in the code. Code-deforming gates are more general and allow a code to be deformed through a sequence of different codes to enact a logical gate. Unlike code-preserving gates, code-deforming gates are generic as they do not necessitate the existence of nontrivial symmetries of the code beyond the logical operators themselves. In particular, code-deforming gates allow for the fault-tolerant measurement of logical operators, which opens up the possibility of implementing measurement-only quantum computation, where Clifford gates and T-gate injections are implemented via measurement, or via Pauli-based computation (PBC), wherein a quantum circuit is compiled into a sequence of generalized magic state injections. Code-deforming gates correspond to fault-tolerant quantum computation via lattice surgery on paths of the surface code. Code-deforming gates are more generic in nature than code-preserving gates as they do not necessitate the existence of nontrivial symmetries of the code beyond the logical operators themselves.

Existing proposals for performing fault-tolerant logical gates on qLDPC codes include code-preserving gates and code-deforming gates. The most direct generalization of surface code lattice surgery is the scheme proposed in Cohen et al. (Cohen L Z, Kim I H, Bartlett S D, Brown B J. Low-overhead fault-tolerant quantum computing using long-range connectivity. Sci Adv. 2022 May 20; 8(20):eabn1717. doi: 10.1126/sciadv.abn1717. Epub 2022 May 20. PMID: 35594359; PMCID: PMC10926894.) where surface codes are replaced by a general LDPC code and an auxiliary code that is similar to a patch of surface code. The auxiliary code in this scheme incurs a qubit overhead of Θ(Wd) where W is the weight of the logical being measured and d is the code distance. For sufficiently low-distance codes with d=O(\sqrt{n}), where n is the number of physical qubits, this suffices to implement measurement-only quantum computation with a linear qubit overhead in n. However, for higher distance codes the qubit overhead becomes super-linear, increasing to Θ(n²) for good codes. Furthermore, for constant-rate codes with small polynomial distances this scheme does not suffice to implement linear qubit overhead PBC as the weight of a generic product of logical operators is expected to scale as Θ(n). This applies, in particular, to constant-rate hypergraph product codes. A recent work modified the scheme from Cohen et al. to reduce its overhead; however this result involves sufficient expansion structure in the logical being measured and the existence of low-weight auxiliary gauge-fixing checks to achieve an advantage over Cohen et al.

Embodiments of the present disclosure introduce a general procedure (a gauging measurement procedure) for the fault-tolerant measurement of a logical operator in a stabilizer code by treating it as physical symmetry and gauging it via measurement. The gauging measurement procedure described in various embodiments herein is common in the theory of condensed matter and high energy physics, and it enforces a global symmetry via a product of local symmetries. However, the gauging measurement procedure is based on the fact that the gauging transformation makes it possible to infer the measurement of a logical operator via a product of local stabilizers in a deformed code. The fault-tolerant gauging measurement procedure described herein can precisely address arbitrary individual logical operators in a large code block. Experimental results corresponding to the gauging measurement procedure prove that the worst-case qubit overhead of the gauging measurement procedure applied to an arbitrary Pauli operator of weight W is O(W log² W), a significant improvement over existing results in the literature. It has been further demonstrated that the flexibility inherent to the gauging measurement procedure can lead to a better performance than existing methods for logical measurement, even for small instances of Bivariate Bicycle (BB) codes.

Gauging has been employed widely in theoretical physics to construct new models and establish relationships between known models. The connection of gauging to quantum codes has also been studied with some existing techniques focusing on gauging procedures that correspond to the simultaneous initialization and readout of all logical qubits in a code without considering fault tolerance. The appearance of a similar procedure in a recent work on weight reduction for quantum codes can hint at wider applications of gauging in quantum error correction.

This section described how several existing techniques for logical measurement can be viewed as gauging measurements.

Remark 11: Lattice surgery is a widely used technique for logical measurements on surface codes. The gauging measurement procedure described in various embodiments herein can be interpreted as a direct generalization of lattice surgery as it recovers conventional lattice surgery when applied to copies of the surface code with an appropriate choice of G. For example, consider the logical operator X̅₁⊗X̅2 supported on the right and left edge of a pair of equally sized surface code blocks, respectively. Applying the gauging measurement with a choice of graph that is a ladder joining the edge qubits of the surface codes as shown in FIG. 4 can result in a deformed code that is again the surface code on the union of the two patches. The final step of measuring out individual edges is the same as conventional lattice surgery. To implement a lattice surgery between surface codes that are not directly adjacent to one another, the gauging measurement procedure can be applied with a graph that includes a grid of dummy vertices between the two edges (see Remark 2).

Interestingly, this procedure can be extended directly to any pair of matching logical X operators on a pair of code blocks. Here, matching means that the restriction of the Z operators in checks overlapping the logical in each code are isomorphic. Similar to lattice surgery, this gauging measurement preserves the code distance for a pair of irreducible logical operators. The logical X operators can be further required to each have the same choice of graph G which is allowed to have low expansion h(G)<1, but is required to satisfy the remaining two desiderata in Remark 3 for each code block. Additional bridge edges can then be added between vertices in the two copies of G, generalizing the choice shown in non-limiting tanner graph 710. Similar to lattice surgery, the gauging measurement defined by such a choice of graph preserves the code distance when the individual logical X operators have minimal weight and contain no sublogical operators. The discussion herein demonstrates that the expansion condition employed in the gauging measurement procedure can be extraneous in certain settings. It appears that expansion is relevant for subsets of qubits that are relevant to the logical operators of the codes being measured. In some embodiments, different expansion conditions can be employed to enable even more efficient logical measurement protocols.

Remark 12: Shor-style logical measurement (P. W. Shor, in Proceedings of 37th conference on foundations of computer science (IEEE, 1996) pp. 56-65) involves entangling an auxiliary Greenberger-Horne-Zeilinger (GHZ) state to a code block via CX gates that are applied transversally between the auxiliary qubits and the support of an X logical operator. The logical operator is then measured by measuring X on each of the auxiliary qubits and discarding them. In various embodiments herein, a similar gauging measurement can be performed by employing a graph that has a separate dummy vertex connected by an edge to each qubit in the support of L, and then a connected graph on the dummy vertices. If performing the gauging measurement is considered where the edges of the connected graph on the dummy qubits are measured first, it leaves a state that corresponds to a GHZ state entangled with the support of L, similar to the Shor-style measurement where the final X measurements are commuted backwards through the CX gates.

Remark 13: A generalized version of the gauging measurement procedure can allow for the replacement of the auxiliary graph with a hypergraph whose adjacent matrix has the same kernel (see Remark 7). This is sufficient to capture the scheme of Cohen et al. (cited in paragraph [00201] for logical measurements. Consider the restriction of the Z-type checks to the support of an irreducible X logical as done in Cohen et al. This defines a hypergraph of Z constraints with the only nontrivial element in the kernel being the logical operator that is to be measured. Next, d layers of dummy vertices can be added for each qubit in the support of L, the d copies of each vertex can be connected via a line graph, and the vertices in each layer can be joined via a copy of the same underlying hypergraph. Applying the generalized gauging measurement procedure to this hypergraph can exactly reproduce the measurement scheme from Cohen et al. The logical measurement scheme from Cross et al. (A. Cross, Z. He, P. Rall, and T. Yoder, arXiv preprint arXiv:2407.18393 (2024)) can similarly be recovered by using fewer than d layers of dummy vertices above. The procedures in Cohen et al. and Cross et al. for joining ancilla systems designed for irreducible logicals to measure their products can also be captured as a gauging measurement by adding edges between the graphs corresponding to the individual ancilla systems.

Remark 14: Generalizing the gauging measurement to a hypergraph allows the measurement of many logical operators simultaneously (see Remark 7). In various embodiments, this approach can be employed to implement the standard initialization of a CSS code by preparing 0^{⊗n} and measuring the X-type checks. This can be achieved by starting with a trivial code with a dummy vertex for each X-type check of the CSS code and then performing the generalized gauging measurement by employing the hypergraph corresponding to the Z-type checks of the CSS code. In this case, the ungauging step simply performs a read-out measurement of Z on all qubits.

In various embodiments, this state preparation and read-out gauging procedure can be combined with another gauging procedure to implement a Steane-style measurement of a stabilizer group (A. Steane, Physical Review Letters 78, 2252 (1996)). This can be achieved by first performing state preparation of an ancilla code block via gauging (as described above) followed by a gauging measurement of XX on pairs of matching qubits between the data code block and the ancilla code block. Finally, the ungauging step can be performed to read-out Z on all ancilla qubits.

### Examples and Discussion

Various embodiments of the present disclosure introduce a method to implement low-overhead fault-tolerant quantum computation with high-distance qLDPC codes. The methods and techniques disclosed herein are based on viewing a logical operator (e.g., logical operator 122) as a symmetry and gauging the logical operator via local measurements. The gauging measurement procedure described in various embodiments herein can allow a high degree of flexibility, making it a promising procedure that can be optimized for even small code instances with near-term applications. Beginning at paragraph [00214], specific gauging measurement schemes for exemplary bivariate bicycle codes that are more efficient than existing measurement schemes have been devised. The present disclosure explains how the flexibility of the gauging measurement procedure can be employed to recover several well-known existing schemes for logical measurement, including surface code lattice surgery, the measurement scheme in Cohen et al. (cited in paragraph [00201]) and the modified version in Cross et al. (cited in paragraph [00208]). This is discussed in greater detail in the following sections. The methods and techniques described by the various embodiments herein can apply to more codes as compared to existing techniques.

In an embodiment, a general purpose decoder based on belief propagation with ordered statistics post-processing can be expected to be employed; however, taking advantage of the extra structure inherent to the gauging measurement procedure to find a decoder with better performance can also be potential solution. Such a decoder can incorporate matching on the Aᵥ syndromes similar to the approach in Cross et al.

### Examples of Bivariate Bicycle (BB) Codes:

In this section, efficient gauging measurements for the bivariate bicycle (BB) codes introduced in Bravyi et al. ((S. Bravyi, A. W. Cross, J. M. Gambetta, D. Maslov, P. Rall, and T. J. Yoder, Nature 627, 778 (2024))) are provided. Let Iᵣ be the r×r identity matrix and Cᵣ be the cyclic permutation matrix of r items, i.e. [symbol] i|Cᵣ= [symbol] i+1 mod r| for all i. Define x= [symbol] ⊗Iₘ and y=Iₗ⊗Cₘ. Note [symbol] =y^{m}= [symbol] and x^{T}x=y^{T}y= [symbol] . BB codes are CSS codes using n=2 [symbol] m physical qubits divided into two sets, [symbol] m left (L) qubits and [symbol] m right (R) qubits. The parity check matrices of a BB code are H_{X}=[A|B], H_{Z}=[B^{T}|A^{T}], where A,B∈ [symbol] ₂[x,y] are polynomials in the matrices x and y. Additionally, A^{T}=A(x,y)^{T}=A(x^{T},y^{T})=A(x⁻¹,y⁻¹) and likewise for B^{T}. There are [symbol] m X checks and [symbol] m Z checks in this generating set, though only (n−k)/2 checks of either type are independent for a code encoding k qubits.

The X checks, Z checks, L qubits, and R qubits are each in 1-to-1 correspondence with the [symbol] m elements of [symbol] ={x^{a}y^{b}:a,b∈ [symbol] }. To label individual checks or qubits, (α,T) can be written for α∈ [symbol] and T∈{X, Z, L, R}. A set of checks or qubits can be more generally indicated by (p,T) for a polynomial p∈ [symbol] ₂[x,y]. For instance, by definition of the code, the X check labeled (α,X) acts on qubits (αA,L) and (αB,R), and the Z check labeled (β,Z) acts on qubits (βB^{T},L) and (βA^{T},R).

An X-type (resp. Z-type) Pauli acting on left qubits (p,L) and right qubits (q,R) for polynomials p, q is more succinctly written X(p,q) (resp. Z(p,q)). For example, the checks described previously are written X(αA,αB) and Z(βB^{T},βA^{T}).

Gross code: The gross code is a 144,12,12 BB code, and is so-called because a “gross” is a dozen dozens or 144. It is obtained from the BB construction by choosing [symbol] =12, m=6, A=x³+y²+y, and B=y³+x²+x. Herein, Aᵢ and Bᵢ have been used for i=1, 2, 3 to denote the individual monomial terms in these polynomials. A convenient basis of logical operators for the gross code was provided in Bravyi et al. (cited in paragraph [00215]). This basis can be described via the following polynomials.

$$f = 1 + x + {x}^{2} + {x}^{3} + {x}^{6} + {x}^{7} + {x}^{8} + {x}^{9} + ( x + {x}^{5} + {x}^{7} + {x}^{11} ) {y}^{3} ,$$

$$g = x + {x}^{2} y + ( 1 + x ) {y}^{2} + {x}^{2} {y}^{3} + {y}^{4} ,$$

$$h = 1 + ( 1 + x ) y + {y}^{2} + ( 1 + x ) {y}^{3} .$$

Then X̅_{α}=X(αf,0) and X̅′_{β}=X(βg,βh) are logical operators for all choices of monomials α, β∈ [symbol] . The symmetry in the BB code construction implies Z̅_{β}=Z(βh^{T},βg^{T}) and Z̅′_{α}=Z(0,αf^{T}) are also logical operators. This symmetry also means that if gauging measurements for X̅_{α} and X̅′_{β} are constructed, the same tanner graph connectivity works for Z̅′_{α} and Z̅_{β}, a fact that was used previously to reduce the number of ancilla systems involved in the measurement of a complete logical basis. It was noted previously that while X̅′_{β} can be measured by mono-layer versions of the CKBB method, the measurement of X̅_{α} can involve several layers. This can be understood as the tanner subgraph supported on X̅_{α} lacking sufficient expansion.

The flexibility of the gauging measurement procedure described in the various embodiments herein can allow for the measurement of X̅_{α} with fewer additional qubits and checks than existing constructions. The goal of measuring X̅_{α} without introducing any new checks or qubits with a tanner graph degree more than 6 (note the 12 qubits in X̅_{α} and the 18 adjacent Z checks become degree 7) can be achieved without decongestion or cellulation. That is, non-limiting tanner graph 700 is sufficient. To specify the construction, G, M, N have been described.

The vertices of graph G are in 1-to-1 correspondence with the qubits {(γ,L):α∈f}, where y∈f indicates a monomial γ that is a term in polynomial f. To ensure that each row of the matrix M (see non-limiting tanner graph 700 of FIG. 7) has weight 1, two vertices γ, δ∈f of G can be connected if qubits (γ,L) and (δ,L) participate in the same Z check. This is the case if and only if

$$γ = {B}_{i}^{T} {B}_{j} δ$$

for some i,j∈{1,2,3}. From this step, G acquires 18 edges and is the same as it would be in the CKBB method. Additional edges can now be added to G to increase its expansion, which can ensure that the deformed code has a code distance equal to the original code (here, distance 12). Constructing a graph with large Cheeger constant can be sufficient but not necessary for the objective discussed herein. Instead, edges can be randomly added to G. It is typically fast to eliminate random trials with low code distances using upper bounds provided by the BP+OSD decoder (as described in Bravyi et al. cited in paragraph) [00215]). If a trial passes the BP+OSD test, then the deformed code distance can be proven to be 12 exactly with integer programming. It was discovered that four additional edges can be sufficient to make a deformed code with distance 12. With vertices labeled by monomials from f, one choice of additional edges can be (x²,x⁵y³), (x²,x⁶), (x⁵y³,x¹¹y³), (x⁷y³,x¹¹y³).

As a connected graph with 12 vertices and 22 edges, G has a minimal cycle basis consisting of 22−12+1=11 cycles. In various embodiments, Gaussian elimination can be employed to find such a basis as the row nullspace of G^{T}, that is, to find full-rank N with 11 rows such that NG^{T}=0. However, because the Z checks of a BB code are not all independent, the Z checks in [symbol] implied by N need not all be independent.

Suppose S is the sub-matrix of H_{Z} containing just the rows describing Z checks in [symbol] (i.e. checks overlapping X̅_{α}) and C is the matrix describing the rest of the Z checks. If uS+vC=0 for some vectors u, v, then u, v identify a product of checks from sets [symbol] and [symbol] in the deformed code that is not supported on the original code. Thus, u, v must represent a cycle uM supported on qubits [symbol] (possibly an empty cycle if u=0). Let U={u:∃v,uS+vC=0}. The number of redundant cycles in any cycle basis is then dimU=row_nullity(H_{Z})−row_nullity(C), which evaluates to 4 for the case at hand. Note that this calculation would change if multiple logical operators were undergoing measurement simultaneously.

Therefore, only 11−4=7 Z checks are needed in [symbol] . These checks can be described as follows as cycles on the vertices of G.

$${x}^{9} \to {x}^{7} {y}^{3} \to {x}^{8} \to {x}^{9}$$

$${x}^{9} \to {x}^{11} {y}^{3} \to {x}^{7} {y}^{3} \to {x}^{9}$$

$${x}^{6} \to {x}^{7} \to {x}^{5} {y}^{3} \to {x}^{6}$$

$${x}^{6} \to {x}^{2} \to {x}^{5} {y}^{3} \to {x}^{6}$$

$${x}^{3} \to {x}^{2} \to {x}^{5} {y}^{3} \to {x}^{3}$$

$${x}^{6} \to {x}^{7} \to {x}^{8} \to {x}^{7} {y}^{3} \to {x}^{6}$$

$$x \to {x}^{2} \to {x}^{5} {y}^{3} \to {x}^{11} {y}^{3} \to x .$$

This completes the description of the gauging measurement of X̅_{α} in the gross code.

To summarize, Table 1 lists check weights and qubit degrees in the deformed code. Beyond the checks and qubits of the original gross code, the code deformation can add 12 X checks in [symbol] , 7 Z checks in [symbol] , and 22 qubits in [symbol] . The additional checks and qubits total 41.

TABLE 1
Check weights and qubit degrees of the deformed code
for measuring X̅_{α} in the gross code.

| | | |
|---|---|---|
| X Checks | Z Checks | qubits |

| weight | count | weight | count | degree | count |
|---|---|---|---|---|---|
| 4 | 7 | 3 | 5 | 3 | 8 |
| 5 | 2 | 4 | 2 | 4 | 9 |
| 6 | 25 | 6 | 54 | 5 | 5 |
| | | 7 | 18 | 6 | 132 |
| | | | | 7 | 12 |

DOUBLE GROSS CODE: Twice as large as the gross code but with larger code distance, the 288,12,18 double gross code is obtained from the BB code construction by taking [symbol] ,m=12,12, and A=x³+y⁷+y², B=y³+x²+x.

One set of logical operators for the double gross code are the weight-18 operators X̅_{α}=X(αf,0) for f=1+x+x²+x⁷+x⁸+x⁹+x¹⁰+x¹¹+ (1+x⁶+x⁸+x¹⁰)y³+(x⁵+x⁶+x⁹+x¹⁰)y⁶+(x⁴+x⁸)y⁹ and all α∈ [symbol] .

In order to measure X̅_{α}=X(αf,0) with gauging measurement, the construction of non-limiting tanner graph 700 was employed and a graph G was constructed with suitable properties. Just as for the gross code, each vertex γ∈ [symbol] of the graph corresponds to a monomial term in f. An edge (γ,δ) is added if

$$γ = {B}_{i}^{T} {B}_{j} δ$$

for some monomials Bᵢ, Bⱼ∈B to ensure a sparse matching matrix M. A total of 27 edges are added this way.

It was observed that an additional 7 edges can also be added to ensure that the deformed code has distance 18. Two of these edges connect the same two vertices, so the resulting graph is a multi-graph.

$$( {x}^{4} {y}^{9} , {x}^{9} {y}^{6} ) , ( {y}^{3} , {x}^{11} ) , ( {x}^{7} , {x}^{10} {y}^{6} ) ,$$

$$( {x}^{8} {y}^{3} , {x}^{10} {y}^{6} ) , ( 1 , {x}^{8} ) , ( {x}^{2} , {x}^{6} {y}^{3} )$$

twice.

Then, a basis of 13 cycles (as given by the following set of mathematical representations) can be identified to complete the construction.

$${x}^{2} \to {x}^{4} {y}^{9} \to {x}^{9} {y}^{6} \to {x}^{10} {y}^{6} \to {x}^{7} \to {x}^{6} {y}^{3} \to {x}^{2}$$

$${x}^{4} {y}^{9} \to {x}^{6} {y}^{6} \to {x}^{8} {y}^{3} \to {x}^{10} {y}^{6} \to {x}^{8} {y}^{9} \to {x}^{9} {y}^{6} \to {x}^{4} {y}^{9}$$

$$1 \to x \to {y}^{3} \to {x}^{10} {y}^{6} \to {x}^{7} \to {x}^{8} \to 1$$

$$1 \to x \to {x}^{2} \to {x}^{6} {y}^{3} \to {x}^{8} \to 1$$

$$1 \to x \to {x}^{2} \to {y}^{3} \to {x}^{11} \to 1$$

$$1 \to {x}^{8} \to {x}^{9} \to {x}^{10} \to {x}^{11} \to 1$$

$${x}^{2} \to {x}^{6} {y}^{3} \to {x}^{5} {y}^{6} \to {x}^{4} {y}^{9} \to {x}^{2}$$

$${x}^{4} {y}^{9} \to {x}^{5} {y}^{6} \to {x}^{6} {y}^{6} \to {x}^{4} {y}^{9}$$

$${x}^{7} \to {x}^{8} \to {x}^{6} {y}^{3} \to {x}^{7}$$

$${x}^{9} \to {x}^{10} \to {x}^{8} {y}^{3} \to {x}^{9}$$

$$1 \to {x}^{11} \to {x}^{10} {y}^{3} \to 1$$

$${x}^{7} \to {x}^{8} {y}^{9} \to {x}^{10} {y}^{6} \to {x}^{7}$$

$${x}^{2} \to {x}^{6} {y}^{3} \to {x}^{2}$$

Check weights and qubit degrees for the double gross code measurement are summarized in Table 2. As for the gross code, a deformed code with the minimal number of weight 7 checks and degree 7 qubits was identified without any higher connectivity. The deformation adds 18 X checks, 13 Z checks, and 34 qubits, totaling 65.

TABLE 2
Check weights and qubit degrees of the deformed code
for measuring X̅_{α} in the double gross code.

| | | |
|---|---|---|
| X Checks | Z Checks | qubits |

| weight | count | weight | count | degree | count |
|---|---|---|---|---|---|
| 4 | 7 | 2 | 1 | 3 | 3 |
| 5 | 8 | 3 | 5 | 4 | 17 |
| 6 | 147 | 4 | 1 | 5 | 12 |
| | | 5 | 3 | 6 | 272 |
| | | 6 | 120 | 7 | 18 |
| | | 7 | 27 | | |

Boundary and Coboundary Maps on a Graph with Specified Cycles:

In this section, elementary definitions of boundary and coboundary maps on a graph G (e.g., auxiliary graph 124) are introduced.

Definition 1 ( [symbol] ₂-Boundary and coboundary maps): In the various embodiments described herein, binary vectors were employed to indicate collections of vertices, edges, and cycles of the graph G. The boundary map ∂ on an edge vector is a [symbol] ₂-linear map that is defined by its action on a single edge ∂e=v+v′ where v and v′ are the adjacent edges of e. The coboundary map is given by the transpose of the boundary map δ=∂^{T} and satisfies δv= [symbol] e. Given a choice of a collection of cycles in G a second boundary map ∂₂ was also defined, whose action on a cycle is ∂₂c= [symbol] e. Similarly, a second coboundary map

$${δ}_{2} = {\partial }_{2}^{T}$$

was defined, which acts on a single edge as δ₂e= [symbol] c.

Remark 15: The maps ∂₂, ∂ form an exact sequence if a generating set of cycles is chosen, and similarly for δ, δ₂. These sequences are not short exact as δ has a nontrivial kernel given by all vertices.

Remark 16: In the present disclosure, notations have been employed by identifying the binary vector associated with a set of vertices, edges, or cycles with the set itself. Where this is done, the meaning is clarified by the context.

### Properties of the Deformed Code:

In this section, the code that occurs during the application of the gauging measurement procedure to a logical operator L (i.e., deformed quantum stabilizer code 126) is analyzed. After measuring the Aᵥ terms in the gauging measurement procedure described in various embodiments herein, a deformed code, also known as the gauged code, was obtained.

Definition 2 (Deformed operator): A Pauli-operator that commutes with L in the initial code can be written P=i^{σ} [symbol] Xᵥ [symbol] Zᵥ for [symbol] _{X}, the support of X and Y operators in P, and [symbol] _{Z} the support of Y and Z operators. Here, | [symbol] _{Z}|=0 mod 2 due to the commutativity condition. From this, a deformed operator via \tilde{P}=sⱼΠ_{e∈γ}Zₑ can be defined, where y is some edge-path in G satisfying ∂γ= [symbol] _{Z}. Choosing a minimum-weight path can be convenient.

Remark 17 (Noncommuting operators): There is no deformed version of a Pauli-operator P that does not commute with L. That is because there is no way to multiply such a P with stabilizers Zₑ and sⱼ to make it commute with all the star operators Aᵥ that are measured to implement the code deformation.

Remark 18 (Deformed checks): The checks from the initial code sⱼ=i^{σ} [symbol] Xᵥ [symbol] Zᵥ become \tilde{s}ⱼ=sⱼ∈_{e∈γ}Zₑ after the gauging measurement deformation, where γ is some edge-path in G satisfying ∂γ= [symbol] _{Z}. For checks that share no Z-type support with L, that is, checks from the set [symbol] , the deformed check is chosen to satisfy \tilde{s}ⱼ=sⱼ. On the other hand, checks from the set [symbol] do share Z-type support with L, and hence, are nontrivially deformed.

Lemma 1 (Deformed code): The following form a generating set of checks for the deformed code:
Aᵥ=Xᵥ [symbol] Xₑ for all v∈G.
Bₚ=Π_{e∈p}Zₑ for a generating set of cycles p∈G.
\tilde{s}ᵢ=sᵢΠ_{e∈γ}Zₑ for all checks in the input code sᵢ

Proof. The Aᵥ operators become checks as they are measured during the gauging process. The Bₚ operators originate from the Zₑ stabilizers on all edge qubits at the initialization step. For a product of these edge stabilizers to remain a check after measuring the Aᵥ operators, it must commute with all [symbol] Xₑ operators. This is equivalent to the product being over edges in a cycle y that satisfies ∂y=0. Similarly, the \tilde{s}ᵢ operators arise from products of sᵢ and Zₑ stabilizers from the initialization step that commute with all Aᵥ operators. This commutation condition is equivalent to the product of Zₑ operators over an edge-path γ satisfying ∂y= [symbol] _{Z}.

Remark 19: By counting the qubits and checks, it is evident that the dimension of the codespace is only reduced by a single qubit, corresponding to the logical operator L that is measured by the gauging deformation. A total of |E_{G}| new qubits are introduced along with |V_{G}| new independent X-type checks and a number of new independent Z-type checks, which number is equal to C, the number of generating cycles of G. This results in |E_{G}|−C−|V_{G}|=−1 by counting. A simple example demonstrating the intuition behind the above formula is given by the cycle graph where |E_{G}|=|V_{G}| and C=1. This provides an alternative method to Theorem 1 to see that no logical information is lost beyond the measurement of L.

Remark 20 (Freedom in defining deformed checks): There is a large degree of freedom when specifying a generating set of checks in the deformed code. If the choice of Aᵥ and sᵢ checks is fixed, then the freedom can be associated with choosing edge-paths p and γ. These choices do not affect the code space because the Bₚ operators for any generating set of cycles in G generate the same algebra. Furthermore, the \tilde{s}ⱼ operator for two different choices of path γ are related by multiplication with Bₚ operators. In practice, the embodiments described herein aim to choose a set of paths p and γ that result in a set of checks with minimal weight and degree.

Definition 3 (Cycle-sparsified graph G̅): Given a graph G and a constant c, the cycle-degree can be called, and a cycle-sparsification of G can be a new graph that can be built by adding edges to copies of G numbered 0, . . . , R. One type of additional edges connect each vertex to its copy in the subsequent layer. The other type of additional edges cellulate a cycle into triangles by connecting vertices as {(1,N−1), (N−1,2), (2,N−2), (N−2,3), . . . } following an ordering of the vertices as they are visited when the cycle is traversed (see non-limiting graph structure 812 of FIG. 8). The cycle-sparsified graph has one copy of each chosen generating cycle cellulated, and the number of cycles any edge participates in must be ≤c for some constant c. In various embodiments,

$${R}_{G}^{c}$$

can be employed to denote the minimal number of layers to achieve a cycle-sparcification of G with constant c. In the present disclosure, the zero (0) layer has been treated as the original graph, and a standard has been followed where none of the cycles in layer 0 are cellulated.

Remark 21: Above we have chosen to cellulate the cycles into triangles as they have minimal weight. A similar procedure applies for squares, or even arbitrary polygons, which need not have a uniform number of edges. Employing squares is natural in the sense that square cycles already appear between layers in the cycle-sparsified graph.

Remark 22: For a constant degree graph, there are Θ(|V_{G}|) cycles in a minimal generating set. For a random expander graph, making an appropriate choice, almost all generating cycles are expected to be of length O(log |V_{G}|). In this case, a cycle-degree of O(log |V_{G}|) and a number of layers

$${R}_{G}^{c} = O ( log \vert {V}_{G} \vert )$$

for cycle-sparsification for a constant c can be expected. It should be noted that the decongestion lemma of Freedman and Hastings (cited in paragraph [0088]) establishes a worst-case bound

$${R}_{G}^{c} = O ( {log}^{2} \vert {V}_{G} \vert )$$

for cycle-sparsification of a constant degree graph (see Remark 4). On the other hand, some cases of the gauging measurement do not involve any sparsification, or more generally,

$${R}_{G}^{c} = O ( 1 ) .$$

Remark 23 (Sparsified deformed checks): When choosing a generating set of checks in a deformed code based on a cycle-sparsification of G, the procedure described herein can take advantage of the layered structure. The basis of cycles and corresponding Bₚ terms are selected to have weight ≤4. This can be achieved by employing a generating set given by squares that connect each adjacent pair of copied edges, and the edges between the associated copied vertices, and the triangles that cellulate each cycle from the original generating set for G. The paths for the deformed \tilde{s}ᵢ checks remain unchanged in the sense that they are all routed through the 0 layer. Assuming G has been chosen such that the length of all paths are upper bounded by a constant K (see Remark 3) can ensure the degree-sparsity of any edge in layer 0. That is because there is a constant upper bound 2 (deg)^{κ} on the number of constant-length paths that can reach a given edge, assuming G has constant degree, and there are a constant number of checks, upper bounded by the check degree of the original code, that can be attached to a path at each vertex. The deformed checks can be further sparsified by routing their paths into additional layers; however a constant degree can be achieved without sparsifying the deformed checks.

Lemma 2 (Space distance): The distance of the deformed code satisfies d*≥min(h(G),1)d, where h(G) is the Cheeger constant of G and d is the distance of the original code.

Proof. A logical operator on the deformed code can be written as

$${L}^{′} = {( i )}^{σ} {L}_{X}^{V} {L}_{Z}^{V} {L}_{X}^{E} {L}_{Z}^{E} \tilde{L} .$$

Here \tilde{L} captures the support of L′ that does not intersect the gauged logical, [symbol] _{X} denotes the X support of L′,

$${L}_{X}^{V} = {X}_{v}$$

captures the intersection of the X support of L′ with the gauged logical,

$${L}_{X}^{E} =$$

captures the X support of L′ on the edges introduced by the gauging procedure, and similarly for Z.

First, the X-type component of the logical operator L′ is considered. The logical operator must commute with the By checks by definition, hence [symbol] = [symbol] _{X}∩E_{G̅} is a 1-cocycle on the graph G̅ as it satisfies δ₂ [symbol] =0. Since the Bₚ terms are defined on a generating set of cycles the sequence formed by δ, δ₂ is exact (see Remark 15). Hence, [symbol] =δ [symbol] for some set of vertices [symbol] ⊂V_{G̅}. From this we have

$${L}_{X}^{E} = {\overline{L}}_{X}^{V} {A}_{v} , {\overline{L}}_{X}^{V} = {X}_{v} .$$

In the definition of

$${\overline{L}}_{X}^{V} ,$$

the product of operators is over vertices in G₀ since the vertices in other layers are dummy vertices that do not support qubits. This generates another logical representative that is equivalent to L′, given by

$$\overline{L} = {i}^{σ} {L}_{X}^{V} {\overline{L}}_{X}^{V} {L}_{2}^{V} {L}_{Z}^{E} \tilde{L} = {L}^{′} {A}_{v} .$$

Next, the Z-type component of the logical operator can be included. It should be noted that the deformed checks \tilde{s}ᵢ are given by the original checks, potentially multiplied with some Zₑ operators. Similarly, the equivalent logical operator L̅ is some operator on the original qubits potentially multiplied by Zₑ operators.

From this, it can be observed that the equivalent logical operator restricted to the qubits of the original code

$${\overline{L} \vert}_{V} = {i}^{σ} {L}_{X}^{V} {\overline{L}}_{X}^{V} {L}_{Z}^{V} \overline{L}$$

must be a logical operator of the original code (i.e., input quantum stabilizer code 120). That is because it must commute with the deformed checks, and since the additional operators on the edge qubits in the deformed checks are all of the form Zₑ, they play no role in the commutation relations. Thus, it can be observed that the full equivalent logical operator L̅ is obtained from the restricted logical L̅|_{V} via the gauging code deformation.

Hence, any logical operator in the deformed code is equivalent to a logical operator on the original code L̅|_{V} potentially multiplied by some Zₑ operators. The weight of any nontrivial logical on the original code, such as L̅|_{V}, can be lower bounded by the distance d. Hence, the weight of the unrestricted logical L̅ can also be lower bounded by d. Furthermore, L̅ can be constructed to have support on no more than half

$$the vortex qubits \leq \frac{\vert {V}_{G} \vert}{2}$$

by optionally multiplying L′ with the stabilizer

$${\prod }_{v ∈ {V}_{\overline{G}}} {A}_{v} .$$

The relative change in operator weight can be lower bounded, induced by the equivalence under multiplication with vertex stabilizers that convert the deformed logical operator L̅ back to the logical operator L′, by the Cheeger constant h(G) of a single layer of the graph G. For a single layer of G, where cycle-sparsification is not applied, this step is straightforward. In the worst case, multiplication with [symbol] Aᵥ to convert L̅ to L′ can remove the support on the vertex set [symbol] and add support on the edge coboundary set [symbol] . Then, | [symbol] |≥h(G)| [symbol] | can be applied to achieve the distance bound on the logical L′.

For a cycle-sparsified graph G̅ this step can be more complicated. In one or more embodiments, the vertices in [symbol] ∩G₀ can be partitioned into two types. The first type can be the vertices for which not all copies of v appear in [symbol] . The second type can be the vertices for which all copies of v appear in [symbol] . For a vertex of the first type, multiplication with Aᵥ stabilizers for v∈ [symbol] can leave the support of an X operator on at least one edge that connects copies of that vertex. For the second type of vertices, multiplication with Aᵥ stabilizers for v∈ [symbol] can clean the support into the adjacent edges on all copies of G and potentially some additional edges introduced to cellulate cycles. Focusing on the set of type-two vertices, it can be observed that after cleaning, the support on the boundary edge set cannot be fully cancelled by any adjacent vertices that have been partially cleaned. This is because for any edge that is in the coboundary edge set of the fully cleaned vertices, and the set of copies of the edge, at least one copy of the edge must support an X operator. This follows from the fact that the product of Aᵥ terms on the adjacent vertex, and its copies, must miss at least one of the copies of G by assumption. Since the combined size of the type-one and type-two vertex sets can be taken

$$\leq \frac{\vert {V}_{G} \vert}{2}$$

we can use the Cheeger constant h(G) to bound the relative size of the coboundary edge set to the type-two vertex set. Finally, as at least one copy of each edge in the coboundary of the type-two vertices has X support, the relative weight of L′ and L̅ can also be lower bounded by h(G). This is a worst case bound that is saturated for X-type logical operators when there is only a single copy of G.

Remark 24: Selecting a graph with Cheeger constant 1 is optimal in the sense that it leads to no reduction in the distance, and a larger Cheeger constant does not improve the distance as the logicals can be cleaned onto the vertices.

Remark 25: The above provides another way to observe that the code deformation preserves all quantum information besides the measurement of the desired logical operator. That is because it defines a 1-to-1 map between logical operators in the deformed quantum stabilizer code and logical operators in the input quantum stabilizer code that commute with the logical operator being gauged. In this mapping, operators that are equivalent to the logical operator being gauged are mapped to stabilizers in the deformed quantum stabilizer code, whereas all distinct logical operators that commute with the logical operator being gauged remain nontrivial as the algebra they generate is preserved under the gauging map.

### Fault-Tolerant Gauging Measurement Procedure:

In this section, further details about the fault-tolerant gauging measurement procedure discussed in various embodiments herein is provided. Herein, a general approach to fault tolerance via repeated measurements (E. Dennis, A. Kitaev, A. Landahl, and J. Preskill, Journal of Mathematical Physics 43, 4452 (2002)) was employed, and some terminology from McEwan et al. (M. McEwen, D. Bacon, and C. Gidney, Quantum 7 (2023), 10.22331/q-2023-11-07-1172) has also been borrowed at places. The gauging measurement procedure can begin at time t₀, followed by at least d cycles of syndrome measurements in the original [[n, k, d]] code. Next, a code deformation step can occur at time tᵢ followed by at least d cycles of syndrome measurements in the deformed code. Finally, there can exist another code deformation step at time to back to the original code, followed by at least d cycles of syndrome measurements in the original code.

Remark 26: A standard for labelling time steps that has check measurements occurring with an offset of half from an integer has been employed. With this standard, detectors and space errors are associated to integer time steps, while measurement errors are associated to integer+half time steps. The initial gauging code deformation measurements were made at time step

$${t}_{i} + \frac{1}{2}$$

and the final ungauging code deformation measurements were made at time step

$${t}_{o} + \frac{1}{2} .$$

Definition 4 (Space and time faults): A space-fault is a Pauli error operator that occurs on some qubit during the implementation of the gauging measurement. A time-fault is a measurement error where the result of a measurement is reported incorrectly during the implementation of the gauging measurement. A general spacetime fault is a collection of space and time faults.

Remark 27: For the purposes of discussion, state misintialization faults to be time faults that are equivalent to space faults by decomposing them into a perfect initialization followed by an error operator.

Definition 5 (Detectors): A detector is a collection of state initializations and measurements that yield a deterministic result in the sense that the product of the observed measurement results must be +1 independent of the individual measurement outcomes, if there are no faults in the procedure.

Definition 6 (Syndrome): The syndrome caused by a spacetime fault is defined to be the set of detectors that are violated in the presence of the fault. That is, the set of detectors that do not satisfy the constraint that the observed measurement results multiply to +1 in the presence of the fault.

Lemma 3 (Spacetime code): The following form a generating set of the local detectors in the fault-tolerant gauging measurement procedure:

For t<tᵢ and t>tₒ

$${s}_{j}^{t}$$

which is given by the collection of repeated sⱼ checks in the original code at times

$$t - \frac{1}{2} , t + \frac{1}{2} .$$

For tᵢ<t<tₒ

$${A}_{v}^{t}$$

which is defined by the repeated measurement of the Aᵥ check in the deformed code at times

$$t - \frac{1}{2} , t + \frac{1}{2} .$$

$${B}_{p}^{t}$$

which is defined similarly for the Bₚ check at times

$$t - \frac{1}{2} , t + \frac{1}{2} .$$

$${\tilde{s}}_{j}^{t}$$

which is defined similarly for the deformed check \tilde{s}ⱼ at times

$$t - \frac{1}{2} , t + \frac{1}{2} .$$

For t=tᵢ

$${B}_{p}^{t} .$$

which is given by the measurement of Bₚ at time

$${t}_{i} + \frac{1}{2}$$

together with the initialization of the edge qubits e∈p in the |0 [symbol] ₑ state at time

$${t}_{i} - \frac{1}{2} .$$

$${\tilde{s}}_{j}^{{t}_{i}}$$

which is given by the measurement of \tilde{s}ⱼ, and the initialization of the edge qubits e∈γ in the |0 [symbol] ₑ state, at time

$${t}_{i} - \frac{1}{2} ,$$

and the measurement of \tilde{s}ⱼ at time

$${t}_{i} + \frac{1}{2} .$$

For t=tₒ

$${B}_{p}^{t}$$

which is given by the measurement of Bₚ at time

$${t}_{o} - \frac{1}{2}$$

and the measurement of Zₑ on the edge qubits e∈p at time

$${t}_{o} + \frac{1}{2} .$$

$${\tilde{s}}_{j}^{{t}_{0}}$$

which is given by the measurement of \tilde{s}ⱼ at time

$${t}_{o} - \frac{1}{2} ,$$

together with the measurement of Zₑ on the edge qubits e∈γ, and sⱼ at time

$${t}_{o} + \frac{1}{2} .$$

Proof. Away from the initial and final steps of the code deformation, the fault-tolerant gauging measurement procedure consists of repeatedly measuring the same checks. In this setting, any local detector must contain a pair of measurements of the same check. This step assumes there are no local relations in the original code (see the remark below). Any detector formed by the measurement of the same check at times (t,t+κ), can be decomposed into detectors at time steps (t,t+1), (t+1,t+2), (t+κ−1,t+κ). During the code deformation there are also detectors that involve the initialization of the edge qubits, and their final read-out. Due to the measurement of Aᵥ terms during the code deformation, any detector involving the initialization of edge qubits in the Z basis must include a collection of edge qubits that corresponds to a product of Bₚ and \tilde{s}ⱼ checks. A similar statement holds for detectors that involve the read-out of edge qubits in the Z basis. Any such detector can be decomposed into one of the detectors involving edges at time tᵢ or tₒ listed above, combined with repeated measurement checks. Local detectors that cross the tᵢ or t_{f} deformation steps must involve a check sⱼ from the original code at some time step before or after the deformation, along with a deformed version \tilde{s}ⱼ. Such a detector can be decomposed into repeated measurement detectors, and one of the detectors involving edge qubits introduced above.

Remark 28 (Space-only detectors): When stating the above lemma, it was assumed that there are no local detectors formed by collections of checks at a single time step. Such detectors occur in codes with local relations or meta-checks, and are useful for single-shot quantum error correction. The fault-tolerant gauging measurement procedure can be applied to codes with local relations. If such local relations are present, modifying Lemma 3 to include the space-only local detectors at each time step can be a simple operation. However, the various embodiments herein do not focus on such codes as the single-shot property of these code does not help reduce the time overhead of the gauging measurement procedure when the scheme described in various embodiments herein in employed.

Remark 29 (Initial and final boundary conditions): Following a reference known in the art, the standard that the initial and final cycle of stabilizer measurements are perfect has been employed. This is to facilitate a clean statement of the results of the various embodiments herein and should not be taken literally. The justification for why this standard does not fundamentally change the results is due to the d cycles of error correction in the original code before and after the gauging measurement. This ensures that any error process that involves both the gauging measurement and the initial or final boundary condition must have distance greater that d. In practice the gauging measurement is intended to be one component of a larger fault-tolerant quantum computation that can determine the appropriate realistic boundary conditions that can be employed.

Remark 30 (Spacetime syndromes): The syndrome of a fault is the set of detectors it causes to have result −1. The fault violates the detectors, and the faults can be organized according to the kind of syndromes they create:

For t<tᵢ and t>tₒ
A Pauli Xᵥ (or Zᵥ) operator fault at time t violates the

$${s}_{j}^{t}$$

detectors for all sⱼ checks that do not commute with Xᵥ (or Zᵥ).
An sⱼ-measurement fault at time

$$t + \frac{1}{2}$$

violates the detectors

$${s}_{j}^{t} and {s}_{j}^{t + 1} .$$

For tᵢ<t<tₒ
A Pauli Xᵥ operator fault at time t violates the

$${\tilde{s}}_{j}^{t}$$

detectors for all \tilde{s}ⱼ checks that do not commute with Xᵥ.
A Pauli Zᵥ operator fault at time t violates the

$${A}_{v}^{t}$$

detector and the

$${\tilde{s}}_{j}^{t}$$

detectors for all \tilde{s}ⱼ checks that do not commute with Zᵥ.
A Pauli Xₑ operator fault at time t violates the

$${B}_{p}^{t}$$

detectors for all p [symbol] e and the

$${\tilde{s}}_{j}^{t}$$

detectors for all \tilde{s}ⱼ checks that anticommute with Xₑ.
A Pauli Zₑ operator fault at time t violates the Aᵥ detectors for v∈e.
A \tilde{s}ⱼ-measurement fault at time

$$t + \frac{1}{2}$$

violates the detectors

$${\tilde{s}}_{j}^{t} and {\tilde{s}}_{j}^{t + 1} .$$

An Aᵥ-measurement fault at time

$$t + \frac{1}{2}$$

violates the detectors

$${A}_{v}^{t} and {A}_{v}^{t + 1} .$$

A Bₚ-measurement fault at time

$$t + \frac{1}{2}$$

violates the detectors

$${B}_{p}^{t} and {B}_{p}^{t + 1} .$$

For t=tᵢ
A Pauli Xᵥ (or Zᵥ) operator fault at time t violates the

$${\tilde{s}}_{j}^{t}$$

detectors for all \tilde{s}ⱼ checks that do not commute with Xᵥ (or Zᵥ).
A Pauli Xₑ operator fault at time t violates the

$${B}_{p}^{t}$$

detectors for all p [symbol] e and the

$${\tilde{s}}_{j}^{t}$$

detectors for all \tilde{s}ⱼ checks that anticommute with Xₑ.
A |0 [symbol] ₑ initialization fault at time

$$t - \frac{1}{2}$$

is equivalent to a Paull Xₑ operator fault at time t and so violates the same detectors.
A \tilde{s}ⱼ-measurement fault at time

$$t + \frac{1}{2}$$

violates the detectors

$${\tilde{s}}_{j}^{t} and {\tilde{s}}_{j}^{t + 1} .$$

An Aᵥ-measurement fault at time

$$t + \frac{1}{2}$$

violates the detector

$${A}_{v}^{t + 1} .$$

A Bₚ-measurement fault at time

$$t + \frac{1}{2}$$

violates the detectors

$${B}_{p}^{t} and {B}_{p}^{t + 1} .$$

For t=tₒ
An Xᵥ (or Zᵥ) Pauli operator fault at time t violates the

$${\tilde{s}}_{j}^{t}$$

detectors for all \tilde{s}ⱼ checks that do not commute with Xᵥ (or Zᵥ).
A Pauli Xₑ operator fault at time t violates the

$${B}_{p}^{t}$$

detectors for all p [symbol] e and the

$${\tilde{s}}_{j}^{t}$$

detectors for all \tilde{s}ⱼ check that anticommute with Xₑ.
A Zₑ-measurement read-out fault at time

$$t + \frac{1}{2}$$

is equivalent to a Paul Xₑ fault at time t and so violates the same detectors.
An sⱼ-measurement fault at time

$$t + \frac{1}{2}$$

violates the detectors

$${\tilde{s}}_{j}^{t} and {s}_{j}^{t + 1} .$$

An Aᵥ-measurement fault at time

$$t - \frac{1}{2} .$$

violates the detector

$${A}_{v}^{t - 1} .$$

Remark 31 (Syndrome mobility): For t<tᵢ and t>tₒ, the syndromes can be created and moved around the code by Pauli errors, and propagated forwards or backwards in time via measurement errors, as usual. For tᵢ<t<tₒ, Pauli errors on vertex qubits behave similarly, with the exception that Zᵥ errors cause additional Aᵥ syndromes. Pauli Zₑ errors on edge qubits form strings that move the Aᵥ syndromes along edge-paths in the graph G. Pauli Xₑ errors on edge qubits produce Bₚ syndromes and can also produce clusters of \tilde{s}ⱼ syndromes that cannot be generated by Pauli errors on the vertex qubits alone. Again, measurement errors can propagate syndromes forwards and backwards in time. At the gauging and ungauging time steps t=tᵢ and t=tₒ, respectively, Aᵥ syndromes can condense, that is, Aᵥ syndromes can be created or destroyed at the time slices where the Aᵥ stabilizer measurements start or end. On the other hand, Bₚ and \tilde{s}ⱼ errors can propagate through the gauging and ungauging time steps by mapping into an error caused by Pauli operators on the vertices alone up to multiplication with spacetime stabilizers including Aᵥ operators (see Lemma 4).

Definition 7 (Spacetime logical fault): A spacetime logical fault is a collection of space and time faults that does not violate any detectors.

Definition 8 (Spacetime stabilizer): A spacetime stabilizer is a trivial spacetime logical fault in the sense that it is a collection of space and time faults that do not violate any detectors and do not affect the result of the gauging measurement procedure.

Lemma 4: The following form a generating set of local spacetime stabilizers:

For t<tᵢ and t>tₒ
A stabilizer check operator sⱼ at time t.
A pair of Pauli Xᵢ (or Zᵢ) faults at times t, t+1, together with measurement faults on all checks sⱼ that do not commute with Xᵢ (or Zᵢ) at time

$$t + \frac{1}{2} .$$

For tᵢ<t<tₒ
A stabilizer check operator \tilde{s}ⱼ, Aᵥ, or Bₚ, at time t.
A pair of vertex Pauli Xᵥ faults at times t, t+1, together with measurement faults on all checks \tilde{s}ⱼ that do not commute with Xᵥ at time

$$t + \frac{1}{2} .$$

A pair of vertex Pauli Zᵥ faults at times t, t+1, together with measurement faults on Aᵥ and all checks \tilde{s}ⱼ that do not commute with Zᵥ at time

$$t + \frac{1}{2} .$$

A pair of edge Pauli Xₑ faults at times t, t+1, together with measurement faults on checks Bₚ with p [symbol] e and all checks \tilde{s}ⱼ that do not commute with Xₑ at time

$$\begin{matrix}t + \\ \frac{1}{2} .\end{matrix}$$

A pair of edge Pauli Zₑ faults at times t, t+1, together with measurement faults on checks Aᵥ with v∈e at time

$$t + \frac{1}{2} .$$

For t=tᵢ
A stabilizer check operator sⱼ or Zₑ at time t.
A pair of vertex Pauli Xᵥ faults at times t, t+1, together with measurement faults on all checks \tilde{s}ⱼ that do not commute with Xᵥ at time

$$t + \frac{1}{2} .$$

A pair of vertex Pauli Zᵥ faults at times t, t+1, together with measurement faults on Aᵥ and all checks \tilde{s}ⱼ that do not commute with Zᵥ at time

$$t + \frac{1}{2} .$$

A pair of edge Pauli Xₑ faults at times t, t+1, together with measurement faults on checks Bₚ with p [symbol] e and all checks \tilde{s}ⱼ that do not commute with Aₑ at time

$$t + \frac{1}{2} .$$

A |0 [symbol] ₑ initialization fault at time

$$t - \frac{1}{2}$$

together with a Pauli Xₑ fault at time t.
A Pauli Zₑ edge fault at time t+1 together with a pair of Aᵥ measurement faults for v∈e at time

$$t + \frac{1}{2} .$$

For t=tₒ
A stabilizer check operator \tilde{s}ⱼ, Aᵥ, or Bₚ at time t.
A pair of vertex Pauli Xᵥ faults at times t, t+1, together with measurement faults on all checks sⱼ that do not commute with Xᵥ at time

$$t + \frac{1}{2} .$$

A pair of vertex Pauli Zᵥ faults at times t, t+1, together with measurement faults on all checks s, that do not commute with Zᵥ at time

$$t + \frac{1}{2} .$$

A Pauli Xₑ edge fault at time t, together with a measurement fault on check Zₑ at time

$$t + \frac{1}{2} .$$

A Pauli Zₑ edge fault at time t.
A Pauli Zₑ edge fault at time t−1 together with a pair of Aᵥ measurement faults for v∈e at time

$$t - \frac{1}{2} .$$

Proof. Any nonempty local spacetime stabilizer must involve a Pauli operator, or equivalent initialization or read-out error. Otherwise, the stabilizer would have to include measurement errors on all repeated measurements of some check. If a non-trivial local spacetime stabilizer contains a Pauli operator at some time, it must be a space stabilizer or contain a Pauli operator at another time, or an equivalent state initialization or measurement read-out error. The product of the Pauli operators from all time steps involved must itself be a space stabilizer, where we are treating initialization and read-out errors as equivalent to some Pauli operator error. Any local spacetime fault of this form can be constructed from a product of the spacetime stabilizers introduced above by first reconstructing the operators at the earliest time step at the cost of creating matching operators at the next time step, and so on until the final time step, where the product of the operators must now become trivial. This leaves a local spacetime stabilizer with only measurement errors, which must also be trivial. Hence, the original fault pattern is a product of the introduced spacetime stabilizers, as described.

Definition 9 (Spacetime fault distance): The spacetime fault distance is the weight, counted in terms of single-site Pauli errors and single measurement errors, of the minimal collection of faults that does not violate any detectors and is not given by a spacetime stabilizer.

Lemma 5 (Time fault distance): The fault distance for measurement and initialization errors is (tₒ−tᵢ).

Proof. With the standard that includes one cycle of perfect measurements at the initial and final steps of the whole procedure (see Remark 29), all pure measurement logical faults must start and end on the code deformation steps. Otherwise, a measurement fault at time step t must be followed and preceded by another measurement fault on the same type of check at time steps t−1, t+1. At this point, it follows that a measurement and initialization logical fault must have distance at least (tₒ−tᵢ), because that is the number of measurement cycles between t₁ and tₒ. Next, the measurement logical faults are more explicitly discussed. At the initial code deformation step, logical measurement faults can terminate in two ways. First, a string of Aᵥ measurement faults can terminate since a fault on the initial measurement of Aᵥ only violates the

$${A}_{v}^{{t}_{i}}$$

detector. Second, a collection of measurement errors on the set of Bₚ and \tilde{s}ⱼ checks that anticommute with some Xₑ operator can terminate since a fault on a |0 [symbol] ₑ edge initialization violates the

$${B}_{p}^{{t}_{i}} and {\tilde{s}}_{j}^{{t}_{i}}$$

detectors for all Bₚ and \tilde{s}ⱼ checks that anticommute with Xₑ. Similarly, at the final code deformation step, a string of Aᵥ measurement errors can terminate and an appropriate collection of Bₚ and \tilde{s}ⱼ measurement errors can terminate. From this, it can be observed that all measurement and initialization logical faults are generated by repeated measurement errors on either a check Aᵥ, or an appropriate collection of Bₚ and \tilde{s}ⱼ checks, at all time steps between tᵢ and tₒ. The logical fault given by repeated measurement error on a collection of Bₚ and \tilde{s}ⱼ checks is in fact a trivial logical fault as it can be decomposed into a product of spacetime stabilizers that consist of an initialization or Xₑ error at some time step, followed by a read-out or Xₑ error at the next time step, and a collection of measurement errors on all Bₚ and \tilde{s}ⱼ checks that anticommute with Xₑ between the time steps. On the other hand, a fault on all repeated measurements of an Aᵥ check results in a logical error as it changes the inferred value of the logical measurement. Hence, the lower bound (tₒ−tᵢ) on the measurement fault distance is saturated.

Remark 32: If a cycle of perfect stabilizer check measurements is not assumed at the start and end of the procedure, it is possible that there are additional logical measurement faults that extend from the initial and final step of the code deformation to the start and end of the whole procedure. For this reason, d cycles of repeated stabilizer measurements have been included in the un-deformed code before and after the gauging measurement code deformation.

Lemma 6 (Decoupling of space and time faults): Any spacetime logical fault is equivalent to the product of a space logical fault and a time logical fault, up to multiplication with spacetime stabilizers.

Proof. Consider an arbitrary spacetime logical fault F. The space component of F, consisting of Pauli operators, can be cleaned into any single timestep tᵢ≤t≤tₒ via multiplication with spacetime stabilizers that involve like Pauli operator faults at time steps t, t+1 together with appropriate measurement faults. In particular, the space component of the logical fault can be cleaned to time step tᵢ. In the cleaned spacetime logical fault, all measurement errors must occur in the time steps tᵢ≤t≤tₒ as measurement errors outside this time window must propagate to the initial or final time boundary, which has no measurement errors by assumption. The measurement faults form strings that propagate through time from

$${t}_{i} \pm \frac{1}{2} to {t}_{o} \pm \frac{1}{2} .$$

These strings must end either at time step

$${t}_{o} - \frac{1}{2}$$

on an Aᵥ measurement fault, or at

$${t}_{o} + \frac{1}{2}$$

on a Zₑ measurement fault. The strings ending on Aᵥ measurement faults are timelike logical faults. The strings ending on a Zₑ measurement fault can all be assumed to originate from a corresponding 0ₑ initialization fault at time step

$${t}_{i} - \frac{1}{2}$$

by multiplying with spacetime stabilizers that introduce pairs of 0ₑ and Xₑ faults. After this equivalence, the strings ending on Zₑ measurement faults are also timelike logical faults. Hence, up to spacetime stabilizer equivalence the original logical can be deformed into a product of timelike logical faults and a residual spacelike fault that must also be a logical fault due to linearity.

Lemma 7 (Spacetime fault distance): The spacetime fault distance of the fault-tolerant gauging measurement procedure is d. Here, it is assumed that a sufficiently expanding graph, satisfying h(G)≥1, and a sufficient number of cycles of repeated measurements, satisfying (tₒ−tᵢ)≥d, are used in the procedure.

Proof. First, consider a spacetime logical fault that is not equivalent to a spacelike logical fault. Such logical faults must have support on all time steps tᵢ<t<tₒ and hence their distance is lower bounded by d, assuming (tₒ−tᵢ)≥d. Now, consider a spacetime logical fault that is equivalent to a spacelike logical fault. Following the proof of Lemma 6, such a fault can be deformed into a spacelike logical fault at time step tᵢ via multiplication with spacetime stabilizers that involve like Pauli operators at time steps t, t+1, and spacetime stabilizers at time step tᵢ that introduce 0ₑ initialization faults along with an Xₑ Pauli faults. Following Lemma 2, the space distance of the resulting spacelike logical is lower bounded by d assuming the Cheeger constant of G satisfies h(G)≥1. Undoing the spacetime stabilizer equivalence that cleaned the spacetime logical into a spacelike logical cannot reduce the distance, since the combined weight of Pauli and initialization faults cannot be reduced below that of the spacelike logical by the spacetime stabilizers that were used in the cleaning process. That is because each such stabilizer preserves the parity of the space and initialization faults along the timeline at a fixed position.

Remark 33: The proof of the spacetime fault distance applies equally well if the plaquette checks Bₚ are high-weight, and if they are measured less frequently than every time step. In fact, it even holds if the Bₚ detectors are only inferred once, via initialization and final readout, avoiding the need to measure high-weight operators. However, in this case the procedure is likely not scalable in the sense that it likely does not have a threshold against uncorrelated random Pauli and measurement noise on all fault sites.

FIG. 14 illustrates a block diagram of an example, non-limiting, operating environment 1400 in which one or more embodiments described herein can be facilitated. FIG. 14 and the following discussion are intended to provide a general description of a suitable operating environment 1400 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as logical operator gauging code 1428. In addition to block 1428, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1428, as identified above), peripheral device set 1414 (including user interface (UI) device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

COMPUTER 1401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method may be distributed among multiple computers and/or between multiple locations. On the other hand, in this presentation of computing environment 1400, detailed discussion is focused on a single computer, specifically computer 1401, to keep the presentation as simple as possible. Computer 1401 may be located in a cloud, even though it is not shown in a cloud in FIG. 14. On the other hand, computer 1401 is not required to be in a cloud except to any extent as may be affirmatively indicated.

PROCESSOR SET 1410 includes one, or more, computer processors of any type now known or to be developed in the future. Processing circuitry 1420 may be distributed over multiple packages, for example, multiple, coordinated integrated circuit chips. Processing circuitry 1420 may implement multiple processor threads and/or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set may be located “off chip.” In some computing environments, processor set 1410 may be designed for working with qubits and performing quantum computing.

Computer-readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1421 and the other storage media discussed below. The program instructions, and associated data, are accessed by processor set 1410 to control and direct performance of the inventive methods. In computing environment 1400, at least some of the instructions for performing the inventive methods may be stored in block 1428 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1412 is any type of volatile memory now known or to be developed in the future. Examples include dynamic type random access memory (RAM) or static type RAM. Typically, volatile memory 1412 is characterized by random access, but this is not required unless affirmatively indicated. In computer 1401, the volatile memory 1412 is located in a single package and is internal to computer 1401, but, alternatively or additionally, the volatile memory may be distributed over multiple packages and/or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 may be a read only memory (ROM), but typically at least a portion of the persistent storage allows writing of data, deletion of data and re-writing of data. Some familiar forms of persistent storage include magnetic disks and solid state storage devices. Operating system 1422 may take several forms, such as various known proprietary operating systems or open source Portable Operating System Interface-type operating systems that employ a kernel. The code included in block 1428 typically includes at least some of the computer code involved in performing the inventive methods.

PERIPHERAL DEVICE SET 1414 includes the set of peripheral devices of computer 1401. Data communication connections between the peripheral devices and the other components of computer 1401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1423 may include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 may be persistent and/or volatile. In some embodiments, storage 1424 may take the form of a quantum computing storage device for storing data in the form of qubits. In embodiments where computer 1401 is required to have a large amount of storage (for example, where computer 1401 locally stores and manages a large database) then this storage may be provided by peripheral storage devices designed for storing very large amounts of data, such as a storage area network (SAN) that is shared by multiple, geographically distributed computers. IoT sensor set 1425 is made up of sensors that can be used in Internet of Things applications. For example, one sensor may be a thermometer and another sensor may be a motion detector.

NETWORK MODULE 1415 is the collection of computer software, hardware, and firmware that allows computer 1401 to communicate with other computers through WAN 1402. Network module 1415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 are performed on physically separate devices, such that the control functions manage several different network hardware devices. Computer-readable program instructions for performing the inventive methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN 1402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401), and may take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 may be a client device, such as thin client, heavy client, mainframe computer, desktop computer and so on.

REMOTE SERVER 1404 is any computer system that serves at least some data and/or functionality to computer 1401. Remote server 1404 may be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data may be provided to computer 1401 from remote database 1430 of remote server 1404.

PUBLIC CLOUD 1405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs may be stored as images and may be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware, and firmware that allows public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1405 and private cloud 1406 are both part of a larger hybrid cloud.

CLOUD COMPUTING SERVICES AND/OR MICROSERVICES (not separately shown in FIG. 14): private and public clouds 1406 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a graph selection component that selects an auxiliary graph; and
a measurement component that measures a logical operator by executing, on a quantum system, a deformed quantum stabilizer code based on the auxiliary graph.

2. The system of claim 1, wherein measuring the logical operator comprises:
initializing, by the measurement component, respective auxiliary qubits for respective edges of the auxiliary graph;
performing, by the measurement component, a first measurement on each vertex of the auxiliary graph and on edges adjacent to the each vertex; and
performing, by the measurement component, a second measurement on each edge of the auxiliary graph.

3. The system of claim 2, wherein the measuring the logical operator further comprises:
performing, by the measurement component, first repeated measurements of original checks for a first number of cycles, wherein an original check is a product of original Pauli matrices; and
performing, by the measurement component, second repeated measurements of deformed checks for a second number of cycles, wherein a deformed check is a product of Pauli matrices based on original qubits and the respective auxiliary qubits.

4. The system of claim 1, further comprising:
a graph construction component that constructs the auxiliary graph, wherein construction of the auxiliary graph comprises:
generating, by the graph construction component, for respective original checks overlapping the logical operator, respective pairings of vertices in respective Pauli operator supports of the respective original checks;
adding, by the graph construction component, respective edges to the auxiliary graph for the respective pairings;
adding, by the graph construction component, one or more additional edges to the auxiliary graph to ensure a desirable expansion of the auxiliary graph; and
identifying, by the graph construction component, a basis of short cycles of the auxiliary graph.

5. The system of claim 4, wherein the construction of the auxiliary graph further comprises:
adding, by the graph construction component, dummy vertices to thicken the auxiliary graph; and
decomposing, by the graph construction component, one or more cycles comprised in the auxiliary graph into one or more smaller cycles.

6. The system of claim 1, wherein the graph selection component selects the auxiliary graph based on connectivity constraints of physical qubits corresponding to the logical operator.

7. The system of claim 1, wherein the auxiliary graph is sufficiently expanding, supports constant-length paths between qubits that are in support of a common check in an input quantum stabilizer code, and comprises a low-weight generating set of cycles.

8. The system of claim 7, further comprising:
a code construction component that constructs the deformed quantum stabilizer code via min-weight perfect matching based on the auxiliary graph and checks of the input quantum stabilizer code, such that the deformed quantum stabilizer code comprises the auxiliary graph and one or more auxiliary qubits.

9. The system of claim 1, wherein the logical operator is a Pauli operator.

10. The system of claim 1, wherein the logical operator is a non-Pauli operator, and the deformed quantum stabilizer code is a non-Pauli code.

11. The system of claim 1, wherein employing the deformed quantum stabilizer code maintains a fault distance associated with the logical operator below a defined threshold.

12. A computer-implemented method, comprising:
selecting, by a system operatively coupled to a processor, an auxiliary graph;
executing, by the system, on a quantum system, a deformed quantum stabilizer code based on the auxiliary graph; and
measuring, by the system, a logical operator based on the executing.

13. The computer-implemented method of claim 12, wherein the measuring comprises:
initializing, by the system, respective auxiliary qubits for respective edges of the auxiliary graph;
performing, by the system, a first measurement on each vertex of the auxiliary graph and on edges adjacent to the each vertex; and
performing, by the system, a second measurement on each edge of the auxiliary graph.

14. The computer-implemented method of claim 13, wherein the measuring further comprises:
performing, by the system, first repeated measurements of original checks for a first number of cycles, wherein an original check is a product of original Pauli matrices; and
performing, by the system, second repeated measurements of deformed checks for a second number of cycles, wherein a deformed check is a product of Pauli matrices based on original qubits and the respective auxiliary qubits.

15. The computer-implemented method of claim 12, further comprising:
constructing, by the system, the auxiliary graph, wherein construction of the auxiliary graph comprises:
generating, by the system, for respective original checks overlapping the logical operator, respective pairings of vertices in respective Pauli operator supports of the respective original checks;
adding, by the system, respective edges to the auxiliary graph for the respective pairings;
adding, by the system, one or more additional edges to the auxiliary graph to ensure a desirable expansion of the auxiliary graph; and
identifying, by the system, a basis of short cycles of the auxiliary graph.

16. The computer-implemented method of claim 15, wherein the construction of the auxiliary graph further comprises:
adding, by the system, dummy vertices to thicken the auxiliary graph; and
decomposing, by the system, one or more cycles comprised in the auxiliary graph into one or more smaller cycles.

17. The computer-implemented method of claim 12, further comprising:
selecting, by the system, the auxiliary graph based on connectivity constraints of physical qubits corresponding to the logical operator.

18. The computer-implemented method of claim 12, further comprising:
constructing, by the system, the deformed quantum stabilizer code via min-weight perfect matching based on the auxiliary graph and checks of an input quantum stabilizer code, such that the deformed quantum stabilizer code comprises the auxiliary graph and one or more auxiliary qubits.

19. A computer program product for low-overhead fault-tolerant quantum computation, the computer program product comprising a computer readable storage medium having program instructions embodied therewith, the program instructions executable by a processor to cause the processor to:
select, by the processor, an auxiliary graph;
execute, by the processor, on a quantum system, a deformed quantum stabilizer code based on the auxiliary graph; and
measure, by the processor, a logical operator based on the executing.

20. The computer program product of claim 19, wherein the program instructions are further executable by the processor to cause the processor to:
initialize, by the processor, respective auxiliary qubits for respective edges of the auxiliary graph;
perform, by the processor, a first measurement on each vertex of the auxiliary graph and on edges adjacent to the each vertex; and
perform, by the processor, a second measurement on each edge of the auxiliary graph.
